(19) United States
(12) Patent Application Publication
(10) Pub. No.: US 2024/0369837 A1
(43) Pub. Date: Nov. 7, 2024

(54) OPTICAL LENS ASSEMBLY AND HEAD-MOUNTED ELECTRONIC DEVICE

(71) Applicant: NEWMAX TECHNOLOGY CO., LTD., Taichung City (TW)

(72) Inventors: Ping-Yi CHEN, Taichung City (TW); Fei-Hsin TSAI, Taichung City (TW); Cong GE, Guangdong Province (CN)

(21) Appl. No.: 18/220,281

(22) Filed: Jul. 11, 2023

(30) Foreign Application Priority Data
May 4, 2023 (TW) 112116542

(51) Int. Cl. G02B 27/01; G02B 9/12; G02B 27/28

(52) U.S. Cl. CPC G02B 27/0172; G02B 9/12; G02B 27/28

(57) ABSTRACT

An optical lens assembly includes a first lens; an optical element group including, in order from a visual side to an image source side: an absorptive polarizer, a reflective polarizer and a phase retarder; a second lens; a third lens; and a partial-reflective-partial-transmissive element. The first lens, the second lens, the third lens and the partial-reflective-partial-transmissive element are sequentially arranged from the visual side to the image source side. The optical element group is disposed between the first lens and the third lens. The phase retarder is disposed between the reflective polarizer and the third lens. The optical lens assembly may become lightweight and have good image quality when satisfying a specific condition.

### BACKGROUND

### Field of the Invention

The present invention relates to an optical lens assembly and head-mounted electronic device, and more particularly to an optical lens assembly applicable to head-mounted electronic devices.

### Description of Related Art

With the development of the semiconductor industry, the functions of various consumer electronic products are increasingly powerful. Moreover, various services of the software application end emerge. These enable consumers to have more choices. Virtual reality (VR) technology emerges when the market is no longer satisfied with handheld electronic products. Nowadays, the application of virtual reality opens up a blue ocean market for consumer electronics, and in the application field of virtual reality, the first commercialized project is the head-mounted display.

However, the current head-mounted displays are heavy and have poor image quality.

The present invention mitigates and/or obviates the aforementioned disadvantages.

### SUMMARY

The objective of the present invention is to provide an optical lens assembly and a head-mounted electronic device, which can reduce the number of lenses by folding the light path, so as to reduce the weight of the device, and also can provide better image quality.

Therefore, an optical lens assembly in accordance with an embodiment of the present invention includes: a first lens with positive refractive power; an optical element group including, in order from a visual side to an image source side: an absorptive polarizer (that is, a first absorptive polarizer), a reflective polarizer and a phase retarder (that is, a first phase retarder); a second lens with refractive power; a third lens with refractive power, and an image source-side surface of the third lens being convex in a paraxial region thereof, and a partial-reflective-partial-transmissive element. The first lens, the second lens, the third lens and the partial-reflective-partial-transmissive element are sequentially arranged from the visual side to the image source side. The optical element group is disposed between the first lens and the third lens. The phase retarder is disposed between the reflective polarizer and the third lens.

In the optical lens assembly, a focal length of the optical lens assembly is f, a focal length of the first lens is f1, a focal length of the second lens is f2, a focal length of the third lens is f3, a radius of curvature of a visual-side surface of the first lens is R1, a radius of curvature of an image source-side surface of the first lens is R2, a radius of curvature of a visual-side surface of the third lens is R5, a radius of curvature of the image source-side surface of the third lens is R6, a thickness of the first lens along an optical axis is CT1, a thickness of the second lens along the optical axis is CT2, a thickness of the third lens along the optical axis is CT3, a maximum effective radius of the visual-side surface of the first lens is CA1, a maximum effective radius of an image source-side surface of the second lens is CA4, an absolute value of a displacement in parallel to the optical axis from an intersection between the visual-side surface of the first lens and the optical axis to the maximum effective radius position on the visual-side surface of the first lens is TDP1, an absolute value of a displacement in parallel to the optical axis from an intersection between the image source-side surface of the first lens and the optical axis to the maximum effective radius position on the image source-side surface of the first lens is TDP2, an absolute value of a displacement in parallel to the optical axis from an intersection between a visual-side surface of the second lens and the optical axis to the maximum effective radius position on the visual-side surface of the second lens is TDP3, an absolute value of a displacement in parallel to the optical axis from an intersection between the visual-side surface of the third lens and the optical axis to the maximum effective radius position on the visual-side surface of the third lens is TDP5, an absolute value of a displacement in parallel to the optical axis from an intersection between the image source-side surface of the third lens and the optical axis to the maximum effective radius position on the image source-side surface of the third lens is TDP6, and at least one of the following condition is satisfied:
5.60<CA1/TDP1<256.36;
0 mm²<TDP5*TDP6<26.95 mm²;
0 mm²<TDP2*TDP3<16.82 mm²;
−3.56<f3/R6<5.12;
3.46<f1/f<12.15;
−124.19<f2/CT2<9.78;
−14.64<f3/f<6.80;
−3.25<f2/f3<−0.25;
−4.04<R1/f1<1.95;
−2.38<R1/R2<8.55;
1.39<CA4/(TDP3+TDP6)<6.68;
−81.96<R1/CT1<150.14;
0.23<CT3/CT2<7.81;
0.45<CT3/TDP6<3.60;
−1.21<f1/f2<2.83;
−0.68<R6/R5<1.67; and
0<R6/R2<1.00.

When 5.60<CA1/TDP1<256.36 is satisfied, it is conducive to achieving a larger field of view and optimizing the formability of the first lens.

When 0 mm²<TDP5*TDP6<26.95 mm² is satisfied, it is conducive to achieving a proper balance between the formability of the third lens and the image quality of the optical lens assembly. When 0 mm²<TDP2*TDP3<16.82 mm² is satisfied, it is conducive to optimizing the assembly stability of the first lens and the second lens.

When −3.56<f3/R6<5.12 is satisfied, it is conducive to adjusting the radius of curvature of the image source-side surface of the third lens, so as to effectively correct the aberration of the image source side.

When 3.46<f1/f<12.15 is satisfied, it is conducive to enhancing the wide-field of view characteristic of the optical lens assembly, providing a larger field of view and maintaining the illumination of the optical lens assembly.

When −124.19<f2/CT2<9.78 is satisfied, it is conducive to achieving a proper balance between the refractive power and the thickness of the second lens.

When −14.64<f3/f<6.80 is satisfied, it is conducive to enhancing the wide-field of view characteristic of the optical lens assembly, providing a larger field of view and maintaining the illumination of the optical lens assembly.

When −3.25<f2/f3<−0.25 is satisfied, it is conducive to achieving the more appropriate distribution of the radius of curvature of the optical lens assembly, thereby reducing the aberration.

When −4.04<R1/f1<1.95 is satisfied, it is conducive to improving the distortion of the optical lens assembly, reducing the aberration of the optical lens assembly, and further reducing the size of the lens.

When −2.38<R1/R2<8.55 is satisfied, it is conducive to preventing the radius of curvature from being too small and reducing the sensitivity to the assembly tolerance as the two radii of curvature are conditioned by each other.

When 1.39<CA4/(TDP3+TDP6)<6.68 is satisfied, it is conducive to achieving a proper balance between the formability of the second lens and the third lens and the image quality of the optical lens assembly.

When −81.96<R1/CT1<150.14 is satisfied, it is conducive to achieving a proper balance between the radius of curvature and the thickness of the first lens.

When 0.23<CT3/CT2<7.81 is satisfied, it is conducive to ensuring that the thickness of the lens can meet the processing requirement of the manufacturing process of the lens device, while ensuring the image quality.

When 0.45<CT3/TDP6<3.60 is satisfied, it is conducive to optimizing the performance and the assembly stability of the third lens.

When −1.21<f1/f2<2.83 is satisfied, it is conducive to achieving the more appropriate distribution of the radius of curvature of the optical lens assembly, thereby reducing the aberration.

When −0.68<R6/R5<1.67 is satisfied, it is conducive to preventing the radius of curvature from being too small and reducing the sensitivity to the assembly tolerance as the two radii of curvature are conditioned by each other.

When 0<R6/R2<1.00 is satisfied, it is conducive to preventing the radius of curvature from being too small and reducing the sensitivity to the assembly tolerance as the two radii of curvature are conditioned by each other.

Optionally, two of the first lens, the second lens and the third lens together form a cemented doublet lens.

Moreover, a head-mounted electronic device in accordance with an embodiment of the present invention includes a housing, the aforementioned optical lens assembly disposed in the housing, an image source disposed on the image source plane of the optical lens assembly in the housing, and a controller disposed in the housing and electrically connected to the image source.

The present invention will be presented in further details from the following descriptions with the accompanying drawings, which show, for purpose of illustrations only, the preferred embodiments in accordance with the present invention.

### BRIEF DESCRIPTION OF THE DRAWINGS

FIG. 1A is a schematic view of an optical lens assembly in accordance with a first embodiment of the present invention;

FIG. 1B is a schematic diagram of a part of the optical lens assembly of FIG. 1A with a light path of a chief ray therein;

FIG. 2 is a schematic view of an optical lens assembly in accordance with a second embodiment of the present invention;

FIG. 3 is a schematic view of an optical lens assembly in accordance with a third embodiment of the present invention;

FIG. 4 is a schematic view of an optical lens assembly in accordance with a fourth embodiment of the present invention;

FIG. 5 is a schematic view of an optical lens assembly in accordance with a fifth embodiment of the present invention;

FIG. 6 is a schematic view of an optical lens assembly in accordance with a sixth embodiment of the present invention;

FIG. 7 is a schematic view of an optical lens assembly in accordance with a seventh embodiment of the present invention;

FIG. 8 is a schematic view of an optical lens assembly in accordance with an eighth embodiment of the present invention; and

FIG. 9 is a schematic diagram of a head-mounted electronic device in accordance with an embodiment of the present invention.

### DETAILED DESCRIPTION

### First Embodiment

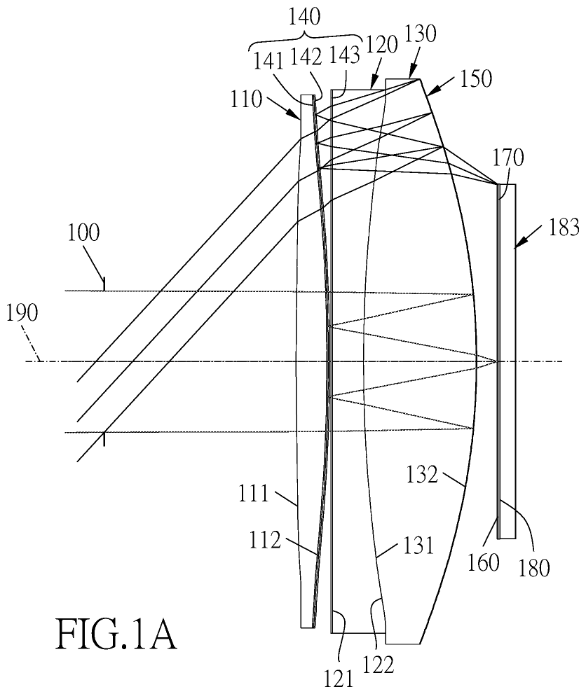

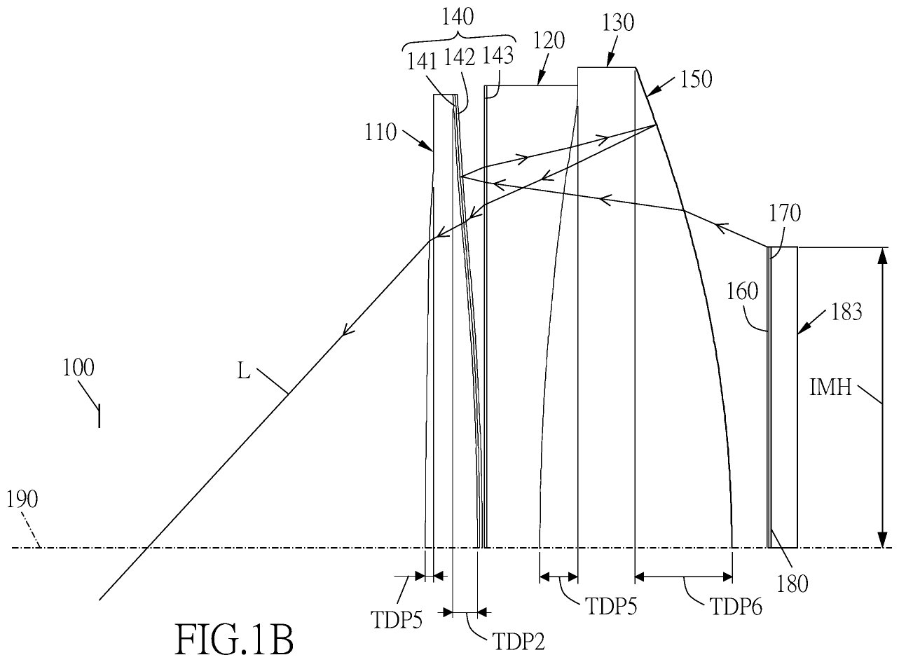

Referring to FIGS. 1A and 1B, an optical lens assembly in accordance with a first embodiment of the present invention includes, in order from a visual side to an image source side along an optical axis 190: a stop 100, a first lens 110, a first absorptive polarizer 141, a reflective polarizer 142, a first phase retarder 143, a second lens 120, a third lens 130, a partial-reflective-partial-transmissive element 150, a second phase retarder 160, a second absorptive polarizer 170 and an image source plane 180. The optical lens assembly has a total of three lenses with refractive power, but not is limited thereto. The first absorptive polarizer 141, the reflective polarizer 142 and the first phase retarder 143 form an optical element group 140 located between the first lens 110 and the third lens 130.

The stop 100 may be located in a position where the user's eyes view an image.

The first lens 110 with positive refractive power includes a visual-side surface 111 and an image source-side surface 112, the visual-side surface 111 of the first lens 110 is convex in a paraxial region thereof, the image source-side surface 112 of the first lens 110 is convex in a paraxial region thereof, the visual-side surface 111 and the image source-side surface 112 of the first lens 110 are aspheric, and the first lens 110 is made of plastic.

The second lens 120 with negative refractive power includes a visual-side surface 121 and an image source-side surface 122, the visual-side surface 121 of the second lens 120 is flat in a paraxial region thereof, the image source-side surface 122 of the second lens 120 is concave in a paraxial region thereof, the image source-side surface 122 of the second lens 120 is aspheric, and the second lens 120 is made of plastic.

The third lens 130 with positive refractive power includes a visual-side surface 131 and an image source-side surface 132, the visual-side surface 131 of the third lens 130 is convex in a paraxial region thereof, the image source-side surface 132 of the third lens 130 is convex in a paraxial region thereof, the visual-side surface 131 and the image source-side surface 132 of the third lens 130 are aspheric, and the third lens 130 is made of plastic. The second lens 120 and the third lens 130 together form a cemented doublet lens.

The first absorptive polarizer 141 is disposed on the image source-side surface 112 of the first lens 110. The reflective polarizer 142 is disposed on an image source-side surface of the first absorptive polarizer 141. The first phase retarder 143 is disposed on the visual-side surface 121 of the second lens 120 and is, for example, but not limited to, a quarter-wave plate.

The partial-reflective-partial-transmissive element 150 is disposed on the image source-side surface 132 of the third lens 130 and has an average reflectance of at least 30%, preferably 50%, in the wavelength range of visible light. The average reflectance here is an average value of different reflectance of the partial-reflective-partial-transmissive element 150 for different wavelengths.

The second absorptive polarizer 170 is disposed on the image source plane 180.

The second phase retarder 160 is disposed on the second absorptive polarizer 170 and is, for example, but not limited to, a quarter-wave plate.

The optical lens assembly works in cooperation with an image source 183 disposed on the image source plane 180. In the present embodiment, the type of the image source 183 is, for example, but not limited to, an OLED display, a LED display, a liquid crystal display, or other displays.

The curve equation for the aspheric surface profiles of the respective lenses of the first embodiment is expressed as follows:

$$z ( h ) = \frac{{ch}^{2}}{1 + {[ 1 - ( k + 1 ) {c}^{2} {h}^{2} ]}^{0.5}} + \sum ( {A}_{i} ) \cdot ( {h}^{i} )$$

wherein:
z represents the value of a reference position at a height of h with respect to a vertex of the surface of a lens along the optical axis 190;
c represents a paraxial curvature (i.e., a curvature of a lens surface in a paraxial region thereof) equal to 1/R (R: a paraxial radius of curvature);
h represents a vertical distance from the point on the curve of the aspheric surface to the optical axis 190;
k represents the conic constant; and
Ai represents the i-th order aspheric coefficient.

The optical lens assembly of the first embodiment utilizes the configuration and arrangement of the absorptive polarizer, the reflective polarizer, the phase retarders, the partial-reflective-partial-transmissive element and the lenses to fold the light path thereof by the transmission and reflection of light to shorten the length of the optical lens assembly required for forming an image without affecting the image quality. In a light path L in FIG. 1B, an unpolarized beam from the image source 183 turns to a circularly-polarized beam after passing through the second absorptive polarizer 170 and the second phase retarder 160. When the circularly-polarized beam transmits to the partial-reflective-partial-transmissive element 150, a component of the circularly-polarized beam passes through the partial-reflective-partial-transmissive element 150, and then passes through the third lens 130, the second lens 120 and the first phase retarder 143 sequentially to turn to a linearly-polarized beam with a polarization direction parallel to the reflective axis of the reflective polarizer 142 and transmit to the reflective polarizer 142. This linearly-polarized beam is reflected by the reflective polarizer 142 and passes through the first phase retarder 143 again to turn to a circularly-polarized beam, and then passes through the second lens 120 and the third lens 130 sequentially to transmit to partial-reflective-partial-transmissive element 150. Then, a component of the circularly-polarized beam is reflected by the partial-reflective-partial-transmissive element 150, and then passes through the third lens 130, the second lens 120 and the first phase retarder 143 sequentially to turn to a linearly-polarized beam with a polarization direction vertical to the reflective axis of the reflective polarizer 142. Finally, the linearly-polarized beam transmits to the user's eyes after passing through the reflective polarizer 142, the first absorptive polarizer 141 and the first lens 110 sequentially.

Please refer to Tables 1-4, Table 1 shows the detailed optical data of the elements of the optical lens assembly of the first embodiment, Table 2 shows the aspheric coefficients of the aspherical surfaces of the elements of the optical lens assembly of the first embodiment, Table 3 shows the remaining parameters of the optical lens assembly of the first embodiment and the values thereof, and the values of the parameters in Tables 1 and 3 meet the conditional formulas of Table 4. A focal length of the first lens 110 is f1, a focal length of the second lens 120 is f2, a focal length of the third lens 130 is f3, a thickness of the first lens 110 along the optical axis 190 is CT1, a thickness of the second lens 120 along the optical axis 190 is CT2, a thickness of the third lens 130 along the optical axis 190 is CT3, a maximum effective radius of the visual-side surface 111 of the first lens 110 is CA1, a maximum effective radius of the image source-side surface 122 of the second lens 120 is CA4, an absolute value of a displacement in parallel to the optical axis 190 from an intersection between the visual-side surface 111 of the first lens 110 and the optical axis 190 to the maximum effective radius position on the visual-side surface 111 of the first lens 110 is TDP1, an absolute value of a displacement in parallel to the optical axis 190 from an intersection between the image source-side surface 112 of the first lens 110 and the optical axis 190 to the maximum effective radius position on the image source-side surface 112 of the first lens 110 is TDP2, an absolute value of a displacement in parallel to the optical axis 190 from an intersection between the visual-side surface 121 of the second lens 120 and the optical axis 190 to the maximum effective radius position on the visual-side surface 121 of the second lens 120 is TDP3, an absolute value of a displacement in parallel to the optical axis 190 from an intersection between the visual-side surface 131 of the third lens 130 and the optical axis 190 to the maximum effective radius position on the visual-side surface 131 of the third lens 130 is TDP5, an absolute value of a displacement in parallel to the optical axis 190 from an intersection between the image source-side surface 132 of the third lens 130 and the optical axis 190 to the maximum effective radius position on the image source-side surface 132 of the third lens 130 is TDP6.

TABLE 1
Embodiment 1
f = 17.04 mm, EPD(Entrance pupil diameter) = 10.00 mm, FOV (Field of view) = 93.1°

| | | Radius of | Thickness/ | Refractive | Abbe | Refraction/ |
|---|---|---|---|---|---|---|
| Surface | | curvature | gap | index (nd) | number (vd) | reflection |
| 0 | Stop | Infinity | 14.000 | — | — | — |
| 1 | First lens | 280.006 | 2.238 | 1.544 | 55.9 | Refraction |
| 2 | First absorptive polarizer | −141.409 | 0.100 | 1.533 | 56.0 | Refraction |
| 3 | Reflective polarizer | −141.409 | 0.100 | 1.533 | 56.0 | Refraction |
| 4 | | −141.409 | 0.100 | — | — | Refraction |
| 5 | First phase retarder | Infinity | 0.100 | 1.533 | 56.0 | Refraction |
| 6 | Second lens | Infinity | 2.276 | 1.645 | 23.4 | Refraction |
| 7 | Third lens | 110.653 | 8.245 | 1.544 | 55.9 | Refraction |
| 8 | Partial-reflective-partial- | −49.005 | −8.245 | 1.544 | 55.9 | Reflection |
| | transmissive element | | | | | |
| 9 | Second lens | 110.653 | −2.276 | 1.645 | 23.4 | Refraction |
| 10 | First phase retarder | Infinity | −0.100 | 1.533 | 56.0 | Refraction |
| 11 | | Infinity | −0.100 | — | — | Refraction |
| 12 | Reflective polarizer | −141.409 | −0.100 | 1.533 | 56.0 | Refraction |
| 13 | Reflective polarizer | −141.409 | 0.100 | 1.533 | 56.0 | Reflection |
| 14 | | −141.409 | 0.100 | — | — | Refraction |
| 15 | First phase retarder | Infinity | 0.100 | 1.533 | 56.0 | Refraction |
| 16 | Second lens | Infinity | 2.276 | 1.645 | 23.4 | Refraction |
| 17 | Third lens | 110.653 | 8.245 | 1.544 | 55.9 | Refraction |
| 18 | Partial-reflective-partial- | −49.005 | 1.500 | — | — | Refraction |
| | transmissive element | | | | | |
| 19 | Second phase retarder | Infinity | 0.100 | 1.533 | 56.0 | Refraction |
| 20 | Second absorptive polarizer | Infinity | 0.100 | 1.533 | 56.0 | Refraction |
| 21 | Image source plane | Infinity | — | — | — | — |

The reference wavelength is 555 nm.

TABLE 2
Embodiment 1
Aspheric Coefficients

| Surface | 1 | 2, 3, 4, 12, 13, 14 | 5, 6, 10, 11, 15, 16 | 7, 9, 17 | 8, 18 |
|---|---|---|---|---|---|
| K: | −7.3688E+01 | 1.8920E+01 | 0.0000E+00 | 1.1313E+01 | 0.0000E+00 |
| A2: | 0.0000E+00 | 0.0000E+00 | 0.0000E+00 | 0.0000E+00 | 0.0000E+00 |
| A4: | −9.2487E−06 | −3.6626E−06 | 0.0000E+00 | 7.7452E−06 | −6.6538E−07 |
| A6: | 3.8685E−08 | 1.5353E−08 | 0.0000E+00 | −6.7659E−08 | 2.0331E−09 |
| A8: | −7.6220E−11 | 2.2310E−11 | 0.0000E+00 | 1.1301E−10 | 3.4439E−12 |
| A10: | 3.1725E−13 | −1.2291E−15 | 0.0000E+00 | 1.6398E−13 | 1.3571E−14 |
| A12: | 3.6272E−16 | 2.4913E−18 | 0.0000E+00 | −1.2421E−16 | −4.1663E−17 |
| A14: | −1.8925E−18 | −2.0238E−19 | 0.0000E+00 | 5.0395E−19 | −3.3919E−20 |
| A16: | −8.9063E−21 | −4.3861E−22 | 0.0000E+00 | −3.6904E−21 | 1.6385E−22 |
| A18: | 3.1908E−24 | 4.0023E−25 | 0.0000E+00 | 0.0000E+00 | 0.0000E+00 |
| A20: | 3.8441E−26 | −1.1879E−27 | 0.0000E+00 | 0.0000E+00 | 0.0000E+00 |

TABLE 3
Embodiment 1

| | | | | | | | |
|---|---|---|---|---|---|---|---|
| f1 | [mm] | 172.51 | CA4 | [mm] | 19.24 | TDP5 [mm] | 1.62 |
| f2 | [mm] | −171.78 | TDP1 | [mm] | 0.34 | TDP6 [mm] | 4.14 |
| f3 | [mm] | 63.40 | TDP2 | [mm] | 0.97 | — | — |
| CA1 | [mm] | 15.76 | TDP3 | [mm] | 0 | — | — |

TABLE 4
Embodiment 1

| | | | | | |
|---|---|---|---|---|---|
| CA1/TDP1 | 45.83 | f3/f | 3.72 | CT3/CT2 | 3.62 |
| TDP5*TDP6 | 6.69 | f2/f3 | −2.71 | CT3/TDP6 | 1.99 |
| [mm²] | | | | | |
| TDP2*TDP3 | 0 | R1/f1 | 1.62 | f1/f2 | −1.00 |
| [mm²] | | | | | |
| f3/R6 | −1.29 | R1/R2 | −1.98 | R6/R5 | −0.44 |
| f1/f | 10.13 | CA4/ | 4.65 | R6/R2 | 0.35 |
| | | (TDP3 + TDP6) | | | |
| f2/CT2 | −75.48 | R1/CT1 | 125.11 | — | — |

In Table 1, the units of the radius of curvature, the thickness, the gap and the focal length are expressed in mm, and the surface numbers 21-0 respectively represent the surfaces to which the light sequentially transmits from the image source plane 180 to the stop 100 along the light path L, wherein the surface 0 represents a gap between the stop 100 (or the user's eyes) and the first lens 110 along the optical axis 190; the surface 1 represents the thickness of the first lens 110 along the optical axis 190; the surface 2 represents the thickness of the first absorptive polarizer 141 along the optical axis 190; the surfaces 3, 12 and 13 represent the thickness of the reflective polarizer 142 along the optical axis 190; the surfaces 4, 11 and 14 represent a gap between the reflective polarizer 142 and the first phase retarder 143 along the optical axis 190; the surfaces 5, 10 and 15 represent the thickness of the first phase retarder 143 along the optical axis 190; the surfaces 6, 9 and 16 represent the thickness of the second lens 120 along the optical axis 190; the surfaces 7 and 17 represent the thickness of the third lens 130 along the optical axis 190; the surface 8 represents a gap between the image source-side surface 132 of the third lens 130 and the image source-side surface 122 of the second lens 120 along the optical axis 190, this gap corresponds to the thickness of the third lens 130 along the optical axis 190; the surfaces 18 represents a gap between the image source-side surface 132 of the third lens 130 and the second phase retarder 160 along the optical axis 190; the surface 19 represents the thickness of the second phase retarder 160 along the optical axis 190; and the surface 20 represents the thickness of the second absorptive polarizer 170 along the optical axis 190. The gaps and thicknesses having a positive sign in Table 1 denote the transmission direction of light is toward the stop 100, and the gaps and thicknesses having a negative sign in Table 1 denote the transmission direction of light is toward the image source plane 180.

In table 2, k represents the conic constant of the equation of aspheric surface profiles, and A2, A4, A6, A8, A10, A12, A14, A16, A18, and A20 represent the high-order aspheric coefficients.

The respective tables presented below for respective one of other embodiments are based on the schematic view of this embodiment, and the definitions of parameters in the tables are the same as those in Tables 1-4 of the first embodiment. However, the definition of each surface number in Table 1 varies with the number of the lenses and the position of the optical elements, and the relevant description of the embodiments may be referred to the definition mode of each surface number in Table 1. Therefore, an explanation in this regard will not be provided again.

### Second Embodiment

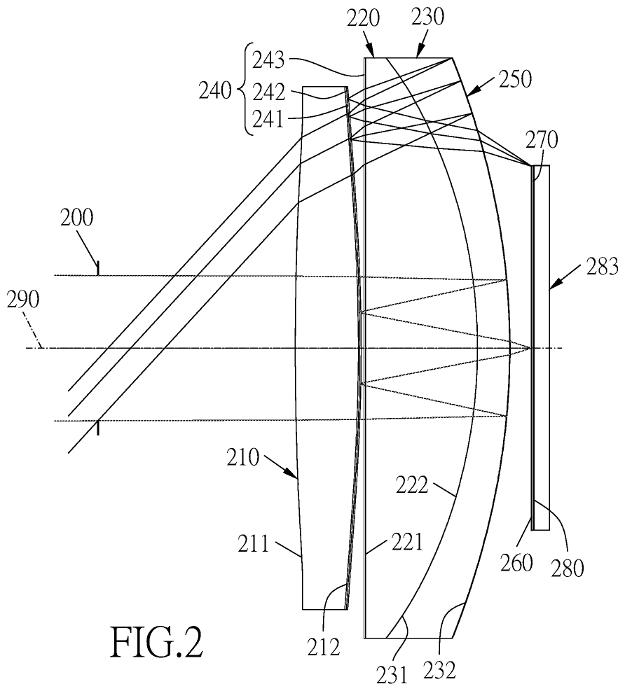

Referring to FIG. 2, an optical lens assembly in accordance with a second embodiment of the present invention includes, in order from a visual side to an image source side along an optical axis 290: a stop 200, a first lens 210, a first absorptive polarizer 241, a reflective polarizer 242, a first phase retarder 243, a second lens 220, a third lens 230, a partial-reflective-partial-transmissive element 250, a second phase retarder 260, a second absorptive polarizer 270 and an image source plane 280. The optical lens assembly has a total of three lenses with refractive power, but not is limited thereto. The first absorptive polarizer 241, the reflective polarizer 242 and the first phase retarder 243 form an optical element group 240 located between the first lens 210 and the third lens 230.

The stop 200 may be located in a position where the user's eyes view an image.

The first lens 210 with positive refractive power includes a visual-side surface 211 and an image source-side surface 212, the visual-side surface 211 of the first lens 210 is convex in a paraxial region thereof, the image source-side surface 212 of the first lens 210 is convex in a paraxial region thereof, the visual-side surface 211 and the image source-side surface 212 of the first lens 210 are aspheric, and the first lens 210 is made of plastic.

The second lens 220 with positive refractive power includes a visual-side surface 221 and an image source-side surface 222, the visual-side surface 221 of the second lens 220 is flat in a paraxial region thereof, the image source-side surface 222 of the second lens 220 is convex in a paraxial region thereof, the image source-side surface 222 of the second lens 220 is aspheric, and the second lens 220 is made of plastic.

The third lens 230 with negative refractive power includes a visual-side surface 231 and an image source-side surface 232, the visual-side surface 231 of the third lens 230 is concave in a paraxial region thereof, the image source-side surface 232 of the third lens 230 is convex in a paraxial region thereof, the visual-side surface 231 and the image source-side surface 232 of the third lens 230 are aspheric, and the third lens 230 is made of plastic. The second lens 220 and the third lens 230 together form a cemented doublet lens.

The configuration of the first absorptive polarizer 241, the reflective polarizer 242 and the first phase retarder 243 is the same as that of the first absorptive polarizer 141, the reflective polarizer 142 and the first phase retarder 143 of the first embodiment and will not be explained again.

The configuration of the partial-reflective-partial-transmissive element 250 is the same as that of the partial-reflective-partial-transmissive element 150 of the first embodiment and will not be explained again.

The configuration of the second phase retarder 260 and the second absorptive polarizer 270 is the same as that of the second phase retarder 160 and the second absorptive polarizer 170 of the first embodiment and will not be explained again.

The optical lens assembly works in cooperation with an image source 283 disposed on the image source plane 280. In the present embodiment, the type of the image source 283 is, for example, but not limited to, an OLED display, a LED display, a liquid crystal display, or other displays.

Please refer to Tables 5-8, Table 5 shows the detailed optical data of the elements of the optical lens assembly of the second embodiment, Table 6 shows the data of the aspherical surfaces of the lenses of the optical lens assembly of the second embodiment, Table 7 shows the remaining parameters of the optical lens assembly of the second embodiment and the values thereof, and the values of the parameters in Tables 5 and 7 meet the conditional formulas of Table 8. In the second embodiment, the equation of the aspheric surface profiles of the aforementioned lenses is the same as the equation of the aspheric surface profiles of the aforementioned lenses in the first embodiment. The definitions of the surfaces in Table 5 can be referred to the relevant description of Table 1 and will not be explained again.

TABLE 5
Embodiment 2
f = 17.18 mm, EPD(Entrance pupil diameter) = 10.00 mm, FOV (Field of view) = 93.1°

| | | Radius of | Thickness/ | Refractive | Abbe | Refraction/ |
|---|---|---|---|---|---|---|
| Surface | | curvature | gap | index (nd) | number (vd) | reflection |
| 0 | Stop | Infinity | 14.000 | — | — | — |
| 1 | First lens | 246.632 | 4.473 | 1.544 | 55.9 | Refraction |
| 2 | First absorptive polarizer | −125.202 | 0.100 | 1.533 | 56.0 | Refraction |
| 3 | Reflective polarizer | −125.202 | 0.100 | 1.533 | 56.0 | Refraction |
| 4 | | −125.202 | 0.200 | — | — | Refraction |
| 5 | First phase retarder | Infinity | 0.100 | 1.533 | 56.0 | Refraction |
| 6 | Second lens | Infinity | 7.948 | 1.544 | 55.9 | Refraction |
| 7 | Third lens | −35.336 | 2.300 | 1.645 | 23.4 | Refraction |
| 8 | Partial-reflective-partial- | −49.082 | −2.300 | — | — | Reflection |
| | transmissive element | | | | | |
| 9 | Second lens | −35.336 | −7.948 | 1.544 | 55.9 | Refraction |
| 10 | First phase retarder | Infinity | −0.100 | 1.533 | 56.0 | Refraction |
| 11 | | Infinity | −0.200 | — | — | Refraction |
| 12 | Reflective polarizer | −125.202 | −0.100 | 1.533 | 56.0 | Refraction |
| 13 | Reflective polarizer | −125.202 | 0.100 | 1.533 | 56.0 | Reflection |
| 14 | | −125.202 | 0.200 | — | — | Refraction |
| 15 | First phase retarder | Infinity | 0.100 | 1.533 | 56.0 | Refraction |
| 16 | Second lens | Infinity | 7.948 | 1.544 | 55.9 | Refraction |
| 17 | Third lens | −35.336 | 2.300 | 1.645 | 23.4 | Refraction |
| 18 | Partial-reflective-partial- | −49.082 | 1.500 | — | — | Refraction |
| | transmissive element | | | | | |
| 19 | Second phase retarder | Infinity | 0.100 | 1.533 | 56.0 | Refraction |
| 20 | Second absorptive | Infinity | 0.100 | 1.533 | 56.0 | Refraction |
| | polarizer | | | | | |
| 21 | Image source plane | Infinity | — | — | — | — |

The reference wavelength is 555 nm.

TABLE 6
Embodiment 2
Aspheric Coefficients

| Surface | 1 | 2, 3, 4, 12, 13, 14 | 5, 6, 10, 11, 15, 16 | 7, 9, 17 | 8, 18 |
|---|---|---|---|---|---|
| K: | 0.0000E+00 | −6.2873E+01 | 0.0000E+00 | 3.9171E−04 | −5.2734E−01 |
| A2: | 0.0000E+00 | 0.0000E+00 | 0.0000E+00 | 0.0000E+00 | 0.0000E+00 |
| A4: | 2.2864E−06 | −1.6405E−07 | 0.0000E+00 | −2.6227E−07 | 3.1156E−07 |
| A6: | −2.6219E−09 | −3.2986E−09 | 0.0000E+00 | −7.8545E−10 | −2.8193E−10 |
| A8: | −5.9311E−12 | 5.5523E−11 | 0.0000E+00 | −4.4810E−12 | 3.0348E−12 |
| A10: | −3.3437E−14 | −1.3154E−13 | 0.0000E+00 | 1.3169E−14 | −1.4888E−15 |
| A12: | −1.7112E−16 | −5.8811E−17 | 0.0000E+00 | −7.7555E−17 | −5.0579E−18 |
| A14: | −3.1664E−19 | 5.0220E−19 | 0.0000E+00 | 1.1466E−19 | −1.2592E−20 |
| A16: | 1.3277E−21 | −4.5651E−22 | 0.0000E+00 | −1.5676E−22 | 1.9700E−23 |
| A18: | 0.0000E+00 | 0.0000E+00 | 0.0000E+00 | 0.0000E+00 | 0.0000E+00 |
| A20: | 0.0000E+00 | 0.0000E+00 | 0.0000E+00 | 0.0000E+00 | 0.0000E+00 |

TABLE 7
Embodiment 2

| | | | | | | | |
|---|---|---|---|---|---|---|---|
| f1 | [mm] | 152.84 | CA4 | [mm] | 18.67 | TDP5 [mm] | 5.50 |
| f2 | [mm] | 64.76 | TDP1 | [mm] | 0.46 | TDP6 [mm] | 4.09 |
| f3 | [mm] | −209.61 | TDP2 | [mm] | 0.89 | — | — |
| CA1 | [mm] | 14.50 | TDP3 | [mm] | 0 | — | — |

TABLE 8
Embodiment 2

| | | | | | |
|---|---|---|---|---|---|
| CA1/TDP1 | 31.32 | f3/f | −12.20 | CT3/CT2 | 0.29 |
| TDP5*TDP6 | 22.46 | f2/f3 | −0.31 | CT3/TDP6 | 0.56 |
| [mm²] | | | | | |
| TDP2*TDP3 | 0 | R1/f1 | 1.61 | f1/f2 | 2.36 |
| [mm²] | | | | | |
| f3/R6 | 4.27 | R1/R2 | −1.97 | R6/R5 | 1.39 |
| f1/f | 8.89 | CA4/ | 4.57 | R6/R2 | 0.39 |
| | | (TDP3 + TDP6) | | | |
| f2/CT2 | 8.15 | R1/CT1 | 55.14 | — | — |

### Third Embodiment

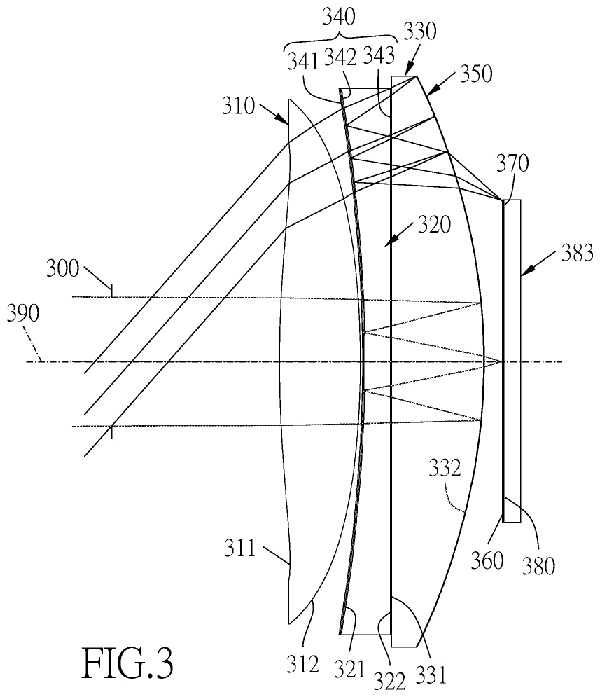

Referring to FIG. 3, an optical lens assembly in accordance with a third embodiment of the present invention includes, in order from a visual side to an image source side along an optical axis 390: a stop 300, a first lens 310, a first absorptive polarizer 341, a reflective polarizer 342, a second lens 320, a first phase retarder 343, a third lens 330, a partial-reflective-partial-transmissive element 350, a second phase retarder 360, a second absorptive polarizer 370 and an image source plane 380. The optical lens assembly has a total of three lenses with refractive power, but not is limited thereto. The first absorptive polarizer 341, the reflective polarizer 342 and the first phase retarder 343 form an optical element group 340 located between the first lens 310 and the third lens 330.

The stop 300 may be located in a position where the user's eyes view an image.

The first lens 310 with positive refractive power includes a visual-side surface 311 and an image source-side surface 312, the visual-side surface 311 of the first lens 310 is convex in a paraxial region thereof, the image source-side surface 312 of the first lens 310 is convex in a paraxial region thereof, the visual-side surface 311 and the image source-side surface 312 of the first lens 310 are aspheric, and the first lens 310 is made of plastic.

The second lens 320 with negative refractive power includes a visual-side surface 321 and an image source-side surface 322, the visual-side surface 321 of the second lens 320 is concave in a paraxial region thereof, the image source-side surface 322 of the second lens 320 is flat in a paraxial region thereof, the visual-side surface 321 of the second lens 320 is aspheric, and the second lens 320 is made of plastic.

The third lens 330 with positive refractive power includes a visual-side surface 331 and an image source-side surface 332, the visual-side surface 331 of the third lens 330 is flat in a paraxial region thereof, the image source-side surface 332 of the third lens 330 is convex in a paraxial region thereof, the image source-side surface 332 of the third lens 330 is aspheric, and the third lens 330 is made of plastic.

The reflective polarizer 342 is disposed on the visual-side surface 321 of the second lens 320. The first absorptive polarizer 341 is disposed on a visual-side surface of the reflective polarizer 342. The first phase retarder 343 is disposed on the image source-side surface 322 of the second lens 320. The third lens 330 is disposed on an image source-side surface of the first phase retarder 343. The first phase retarder 343 is, for example, but not limited to, a quarter-wave plate.

The configuration of the partial-reflective-partial-transmissive element 350 is the same as that of the partial-reflective-partial-transmissive element 150 of the first embodiment and will not be explained again.

The configuration of the second phase retarder 360 and the second absorptive polarizer 370 is the same as that of the second phase retarder 160 and the second absorptive polarizer 170 of the first embodiment and will not be explained again.

The optical lens assembly works in cooperation with an image source 383 disposed on the image source plane 380. In the present embodiment, the type of the image source 383 is, for example, but not limited to, an OLED display, a LED display, a liquid crystal display, or other displays.

Please refer to Tables 9-12, Table 9 shows the detailed optical data of the elements of the optical lens assembly of the third embodiment, Table 10 shows the data of the aspherical surfaces of the lenses of the optical lens assembly of the third embodiment, Table 11 shows the remaining parameters of the optical lens assembly of the third embodiment and the values thereof, and the values of the parameters in Tables 9 and 11 meet the conditional formulas of Table 12. In the third embodiment, the equation of the aspheric surface profiles of the aforementioned lenses is the same as the equation of the aspheric surface profiles of the aforementioned lenses in the first embodiment. The definitions of the surfaces in Table 9 can be referred to the relevant description of Table 1 and will not be explained again.

TABLE 9
Embodiment 3
f = 17.22 mm, EPD(Entrance pupil diameter) = 10.00 mm, FOV (Field of view) = 93.1°

| | | Radius of | Thickness/ | Thickness/ | Abbe number | Refraction/ |
|---|---|---|---|---|---|---|
| Surface | | curvature | gap | gap | (vd) | reflection |
| 0 | Stop | Infinity | 14.000 | — | — | — |
| 1 | First lens | 90.236 | 6.710 | 1.544 | 55.9 | Refraction |
| 2 | | −71.975 | 0.200 | — | — | Refraction |
| 3 | First absorptive polarizer | −100.606 | 0.100 | 1.533 | 56.0 | Refraction |
| 4 | Reflective polarizer | −100.606 | 0.100 | 1.533 | 56.0 | Refraction |
| 5 | Second lens | −100.606 | 2.100 | 1.645 | 23.4 | Refraction |
| 6 | First phase retarder | Infinity | 0.100 | 1.533 | 56.0 | Refraction |
| 7 | Third lens | Infinity | 7.694 | 1.544 | 55.9 | Refraction |
| 8 | Partial-reflective-partial- | −44.113 | −7.694 | 1.544 | 55.9 | Reflection |
| | transmissive element | | | | | |
| 9 | First phase retarder | Infinity | −0.100 | 1.533 | 56.0 | Refraction |
| 10 | Second lens | Infinity | −2.100 | 1.645 | 23.4 | Refraction |
| 11 | Reflective polarizer | −100.606 | −0.100 | 1.533 | 56.0 | Refraction |
| 12 | Reflective polarizer | −100.606 | 0.100 | 1.533 | 56.0 | Reflection |
| 13 | Second lens | −100.606 | 2.100 | 1.645 | 23.4 | Refraction |
| 14 | First phase retarder | Infinity | 0.100 | 1.533 | 56.0 | Refraction |
| 15 | Third lens | Infinity | 7.694 | 1.544 | 55.9 | Refraction |
| 16 | Partial-reflective-partial- | −44.113 | 1.500 | — | — | Refraction |
| | transmissive element | | | | | |
| 17 | Second phase retarder | Infinity | 0.100 | 1.533 | 56.0 | Refraction |
| 18 | Second absorptive | Infinity | 0.100 | 1.533 | 56.0 | Refraction |
| | polarizer | | | | | |
| 19 | Image source plane | Infinity | — | — | — | — |

The reference wavelength is 555 nm.

TABLE 10
Embodiment 3
Aspheric Coefficients

| Surface | 1 | 2 | 3, 4, 5, 11, 12, 13 |
|---|---|---|---|
| K: | −9.0000E+01 | 9.4230E+00 | 4.0088E+00 |
| A2: | 0.0000E+00 | 0.0000E+00 | 0.0000E+00 |
| A4: | 6.1359E−06 | −6.7702E−06 | 1.1324E−06 |
| A6: | −1.0848E−08 | 1.3396E−08 | 1.7937E−08 |
| A8: | −1.1946E−10 | −5.2971E−11 | −4.9506E−11 |
| A10: | 2.2768E−13 | −5.5014E−14 | −5.2005E−14 |
| A12: | 1.9855E−16 | 2.9816E−16 | 2.8320E−16 |
| A14: | −9.5122E−19 | −3.7623E−19 | −3.4757E−19 |
| A16: | −4.8660E−21 | −5.8223E−23 | 2.9740E−22 |
| A18: | 1.1606E−23 | 0.0000E+00 | 0.0000E+00 |
| A20: | −9.8477E−27 | 0.0000E+00 | 0.0000E+00 |

| Surface | 6, 10, 14 | 7, 9, 15 | 8, 16 |
|---|---|---|---|
| K: | 0.0000E+00 | 0.0000E+00 | 0.0000E+00 |
| A2: | 0.0000E+00 | 0.0000E+00 | 0.0000E+00 |
| A4: | 0.0000E+00 | 0.0000E+00 | 6.9513E−07 |
| A6: | 0.0000E+00 | 0.0000E+00 | 5.2829E−09 |
| A8 | 0.0000E+00 | 0.0000E+00 | −4.4775E−12 |
| A10: | 0.0000E+00 | 0.0000E+00 | 5.4438E−15 |
| A12: | 0.0000E+00 | 0.0000E+00 | −3.5080E−17 |
| A14: | 0.0000E+00 | 0.0000E+00 | −4.0903E−21 |
| A16: | 0.0000E+00 | 0.0000E+00 | 5.6461E−23 |
| A18: | 0.0000E+00 | 0.0000E+00 | 0.0000E+00 |
| A20: | 0.0000E+00 | 0.0000E+00 | 0.0000E+00 |

TABLE 11
Embodiment 3

| | | | | | | | |
|---|---|---|---|---|---|---|---|
| f1 | [mm] | 74.46 | CA4 | [mm] | 21.22 | TDP5 [mm] | 0 |
| f2 | [mm] | −156.18 | TDP1 | [mm] | 0.77 | TDP6 [mm] | 5.61 |
| f3 | [mm] | 80.84 | TDP2 | [mm] | 3.87 | — | — |
| CA1 | [mm] | 17.00 | TDP3 | [mm] | 1.73 | — | — |

TABLE 12
Embodiment 3

| | | | | | |
|---|---|---|---|---|---|
| CA1/TDP1 | 22.02 | f3/f | 4.69 | CT3/CT2 | 3.66 |
| TDP5*TDP6 | 0 | f2/f3 | −1.93 | CT3/TDP6 | 1.37 |
| [mm²] | | | | | |
| TDP2*TDP3 | 6.72 | R1/f1 | 1.21 | f1/f2 | −0.48 |
| [mm²] | | | | | |
| f3/R6 | −1.83 | R1/R2 | −1.25 | R6/R5 | 0 |
| f1/f | 4.32 | CA4/ | 2.89 | R6/R2 | 0.61 |
| | | (TDP3 + TDP6) | | | |
| f2/CT2 | −74.37 | R1/CT1 | 13.45 | — | — |

### Fourth Embodiment

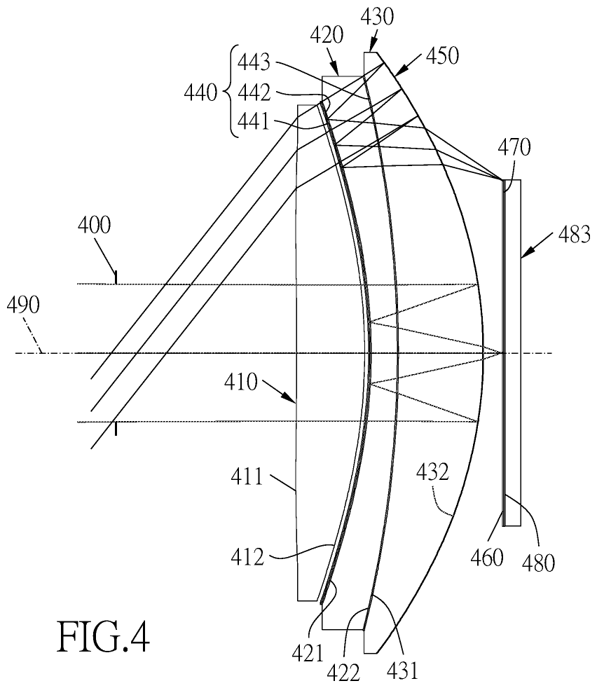

Referring to FIG. 4, an optical lens assembly in accordance with a fourth embodiment of the present invention includes, in order from a visual side to an image source side along an optical axis 490: a stop 400, a first lens 410, a first absorptive polarizer 441, a reflective polarizer 442, a second lens 420, a first phase retarder 443, a third lens 430, a partial-reflective-partial-transmissive element 450, a second phase retarder 460, a second absorptive polarizer 470 and an image source plane 480. The optical lens assembly has a total of three lenses with refractive power, but not is limited thereto. The first absorptive polarizer 441, the reflective polarizer 442 and the first phase retarder 443 form an optical element group 440 located between the first lens 410 and the third lens 430.

The stop 400 may be located in a position where the user's eyes view an image.

The first lens 410 with positive refractive power includes a visual-side surface 411 and an image source-side surface 412, the visual-side surface 411 of the first lens 410 is concave in a paraxial region thereof, the image source-side surface 412 of the first lens 410 is convex in a paraxial region thereof, the visual-side surface 411 and the image source-side surface 412 of the first lens 410 are aspheric, and the first lens 410 is made of plastic.

The second lens 420 with negative refractive power includes a visual-side surface 421 and an image source-side surface 422, the visual-side surface 421 of the second lens 420 is concave in a paraxial region thereof, the image source-side surface 422 of the second lens 420 is convex in a paraxial region thereof, the visual-side surface 421 and the image source-side surface 422 of the second lens 420 are aspheric, and the second lens 420 is made of plastic.

The third lens 430 with positive refractive power includes a visual-side surface 431 and an image source-side surface 432, the visual-side surface 431 of the third lens 430 is concave in a paraxial region thereof, the image source-side surface 432 of the third lens 430 is convex in a paraxial region thereof, the visual-side surface 431 and the image source-side surface 432 of the third lens 430 are aspheric, and the third lens 430 is made of plastic.

The configuration of the first absorptive polarizer 441, the reflective polarizer 442 and the first phase retarder 443 is the same as that of the first absorptive polarizer 341, the reflective polarizer 342 and the first phase retarder 343 of the third embodiment and will not be explained again.

The configuration of the partial-reflective-partial-transmissive element 450 is the same as that of the partial-reflective-partial-transmissive element 150 of the first embodiment and will not be explained again.

The configuration of the second phase retarder 460 and the second absorptive polarizer 470 is the same as that of the second phase retarder 160 and the second absorptive polarizer 170 of the first embodiment and will not be explained again.

The optical lens assembly works in cooperation with an image source 483 disposed on the image source plane 480. In the present embodiment, the type of the image source 483 is, for example, but not limited to, an OLED display, a LED display, a liquid crystal display, or other displays.

Please refer to Tables 13-16, Table 13 shows the detailed optical data of the elements of the optical lens assembly of the fourth embodiment, Table 14 shows the data of the aspherical surfaces of the lenses of the optical lens assembly of the fourth embodiment, Table 15 shows the remaining parameters of the optical lens assembly of the fourth embodiment and the values thereof, and the values of the parameters in Tables 13 and 15 meet the conditional formulas of Table 16. In the fourth embodiment, the equation of the aspheric surface profiles of the aforementioned lenses is the same as the equation of the aspheric surface profiles of the aforementioned lenses in the first embodiment. The definitions of the surfaces in Table 13 can be referred to the relevant description of Table 1 and will not be explained again.

TABLE 13
Embodiment 4
f = 15.74 mm, EPD(Entrance pupil diameter) = 10.00 mm, FOV (Field of view) = 99.7°

| | | Radius of | Thickness/ | Refractive | Abbe | Refraction/ |
|---|---|---|---|---|---|---|
| Surface | | curvature | gap | index (nd) | number (vd) | reflection |
| 0 | Stop | Infinity | 14.000 | — | — | — |
| 1 | First lens | −275.461 | 5.272 | 1.544 | 55.9 | Refraction |
| 2 | | −38.654 | 0.300 | — | — | Refraction |
| 3 | First absorptive polarizer | −38.654 | 0.100 | 1.533 | 56.0 | Refraction |
| 4 | Reflective polarizer | −38.654 | 0.100 | 1.533 | 56.0 | Refraction |
| 5 | Second lens | −38.654 | 2.022 | 1.645 | 23.4 | Refraction |
| 6 | First phase retarder | −77.809 | 0.100 | 1.533 | 56.0 | Refraction |
| 7 | third lens | −77.809 | 6.573 | 1.544 | 55.9 | Refraction |
| 8 | Partial-reflective-partial- | −30.755 | −6.573 | 1.544 | 55.9 | Reflection |
| | transmissive element | | | | | |
| 9 | First phase retarder | −77.809 | −0.100 | 1.533 | 56.0 | Refraction |
| 10 | Second lens | −77.809 | −2.022 | 1.645 | 23.4 | Refraction |
| 11 | Reflective polarizer | −38.654 | −0.100 | 1.533 | 56.0 | Refraction |
| 12 | Reflective polarizer | −38.654 | 0.100 | 1.533 | 56.0 | Reflection |
| 13 | Second lens | −38.654 | 2.022 | 1.645 | 23.4 | Refraction |
| 14 | First phase retarder | −77.809 | 0.100 | 1.533 | 56.0 | Refraction |
| 15 | third lens | −77.809 | 6.573 | 1.544 | 55.9 | Refraction |
| 16 | Partial-reflective-partial- | −30.755 | 1.500 | — | — | Refraction |
| | transmissive element | | | | | |
| 17 | Second phase retarder | Infinity | 0.100 | 1.533 | 56.0 | Refraction |
| 18 | Second absorptive | Infinity | 0.100 | 1.533 | 56.0 | Refraction |
| | polarizer | | | | | |
| 19 | Image source plane | Infinity | — | — | — | — |

The reference wavelength is 555 nm.

TABLE 14
Embodiment 4
Aspheric Coefficients

| Surface | 1 | 2 | 3, 4, 5, 11, 12, 13 |
|---|---|---|---|
| K: | 8.1872E+01 | −2.0573E+00 | −2.0573E+00 |
| A2: | 0.0000E+00 | 0.0000E+00 | 0.0000E+00 |
| A4: | 1.5722E−05 | 2.8111E−06 | 2.8111E−06 |
| A6: | −4.4174E−08 | −4.6262E−09 | −4.6262E−09 |
| A8: | 1.2229E−10 | 3.6546E−11 | 3.6546E−11 |
| A10: | −2.5624E−13 | −2.2761E−13 | −2.2761E−13 |
| A12: | 4.7857E−16 | 1.0929E−15 | 1.0929E−15 |
| A14: | −1.2202E−18 | −1.8968E−18 | −1.8968E−18 |
| A16: | 0.0000E+00 | 0.0000E+00 | 0.0000E+00 |
| A18: | 0.0000E+00 | 0.0000E+00 | 0.0000E+00 |
| A20: | 0.0000E+00 | 0.0000E+00 | 0.0000E+00 |

| Surface | 6, 10, 14 | 7, 9, 15 | 8, 16 |
|---|---|---|---|
| K: | 0.0000E+00 | 0.0000E+00 | 0.0000E+00 |
| A2: | 0.0000E+00 | 0.0000E+00 | 0.0000E+00 |
| A4: | 0.0000E+00 | 0.0000E+00 | 1.5854E−06 |
| A6: | 0.0000E+00 | 0.0000E+00 | 9.1794E−10 |
| A8: | 0.0000E+00 | 0.0000E+00 | 1.1223E−11 |
| A10: | 0.0000E+00 | 0.0000E+00 | −2.8284E−14 |
| A12: | 0.0000E+00 | 0.0000E+00 | 1.9389E−17 |
| A14: | 0.0000E+00 | 0.0000E+00 | 2.4992E−19 |
| A16: | 0.0000E+00 | 0.0000E+00 | −4.3153E−22 |
| A18: | 0.0000E+00 | 0.0000E+00 | 0.0000E+00 |
| A20: | 0.0000E+00 | 0.0000E+00 | 0.0000E+00 |

TABLE 15
Embodiment 4

| | | | | | | | |
|---|---|---|---|---|---|---|---|
| f1 | [mm] | 81.76 | CA4 | [mm] | 20.10 | TDP5 [mm] | 2.65 |
| f2 | [mm] | −121.71 | TDP1 | [mm] | 0.08 | TDP6 [mm] | 7.67 |
| f3 | [mm] | 88.82 | TDP2 | [mm] | 3.69 | — | — |
| CA1 | [mm] | 17.09 | TDP3 | [mm] | 3.80 | — | — |

TABLE 16
Embodiment 4

| | | | | | |
|---|---|---|---|---|---|
| CA1/TDP1 | 213.64 | f3/f | 5.64 | CT3/CT2 | 3.25 |
| TDP5*TDP6 | 20.37 | f2/f3 | −1.37 | CT3/TDP6 | 0.86 |
| [mm²] | | | | | |
| TDP2*TDP3 | 14.01 | R1/f1 | −3.37 | f1/f2 | −0.67 |
| [mm²] | | | | | |
| f3/R6 | −2.89 | R1/R2 | 7.13 | R6/R5 | 0.40 |
| f1/f | 5.19 | CA4/ | 1.75 | R6/R2 | 0.80 |
| | | (TDP3 + TDP6) | | | |
| f2/CT2 | −60.20 | R1/CT1 | −52.25 | — | — |

### Fifth Embodiment

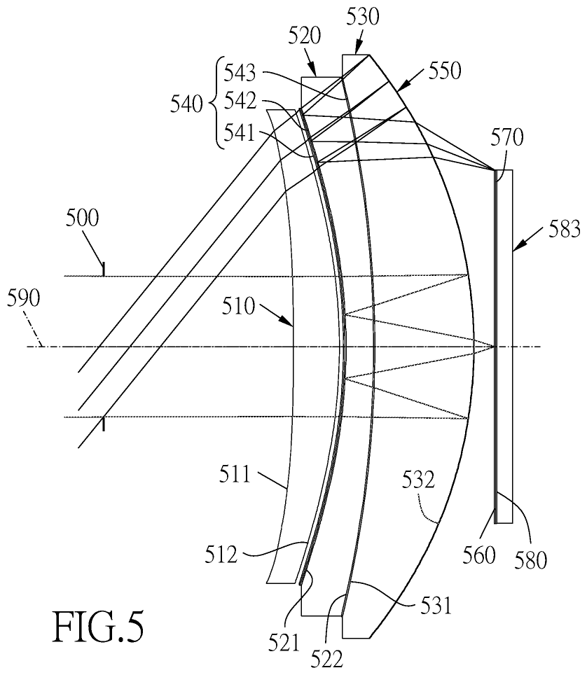

Referring to FIG. 5, an optical lens assembly in accordance with a fifth embodiment of the present invention includes, in order from a visual side to an image source side along an optical axis 590: a stop 500, a first lens 510, a first absorptive polarizer 541, a reflective polarizer 542, a second lens 520, a first phase retarder 543, a third lens 530, a partial-reflective-partial-transmissive element 550, a second phase retarder 560, a second absorptive polarizer 570 and an image source plane 580. The optical lens assembly has a total of three lenses with refractive power, but not is limited thereto. The first absorptive polarizer 541, the reflective polarizer 542 and the first phase retarder 543 form an optical element group 540 located between the first lens 510 and the third lens 530.

The stop 500 may be located in a position where the user's eyes view an image.

The first lens 510 with positive refractive power includes a visual-side surface 511 and an image source-side surface 512, the visual-side surface 511 of the first lens 510 is concave in a paraxial region thereof, the image source-side surface 512 of the first lens 510 is convex in a paraxial region thereof, the visual-side surface 511 and the image source-side surface 512 of the first lens 510 are aspheric, and the first lens 510 is made of plastic.

The second lens 520 with negative refractive power includes a visual-side surface 521 and an image source-side surface 522, the visual-side surface 521 of the second lens 520 is concave in a paraxial region thereof, the image source-side surface 522 of the second lens 520 is convex in a paraxial region thereof, the visual-side surface 521 and the image source-side surface 522 of the second lens 520 are aspheric, and the second lens 520 is made of plastic.

The third lens 530 with positive refractive power includes a visual-side surface 531 and an image source-side surface 532, the visual-side surface 531 of the third lens 530 is concave in a paraxial region thereof, the image source-side surface 532 of the third lens 530 is convex in a paraxial region thereof, the visual-side surface 531 and the image source-side surface 532 of the third lens 530 are aspheric, and the third lens 530 is made of plastic.

The configuration of the first absorptive polarizer 541, the reflective polarizer 542 and the first phase retarder 543 is the same as that of the first absorptive polarizer 341, the reflective polarizer 342 and the first phase retarder 343 of the third embodiment and will not be explained again.

The configuration of the partial-reflective-partial-transmissive element 550 is the same as that of the partial-reflective-partial-transmissive element 150 of the first embodiment and will not be explained again.

The configuration of the second phase retarder 560 and the second absorptive polarizer 570 is the same as that of the second phase retarder 160 and the second absorptive polarizer 170 of the first embodiment and will not be explained again.

The optical lens assembly works in cooperation with an image source 583 disposed on the image source plane 580. In the present embodiment, the type of the image source 583 is, for example, but not limited to, an OLED display, a LED display, a liquid crystal display, or other displays.

Please refer to Tables 17-20, Table 17 shows the detailed optical data of the elements of the optical lens assembly of the fifth embodiment, Table 18 shows the data of the aspherical surfaces of the lenses of the optical lens assembly of the fifth embodiment, Table 19 shows the remaining parameters of the optical lens assembly of the fifth embodiment and the values thereof, and the values of the parameters in Tables 17 and 19 meet the conditional formulas of Table 20. In the fifth embodiment, the equation of the aspheric surface profiles of the aforementioned lenses is the same as the equation of the aspheric surface profiles of the aforementioned lenses in the first embodiment. The definitions of the surfaces in Table 17 can be referred to the relevant description of Table 1 and will not be explained again.

TABLE 17
Embodiment 5
f = 16.95 mm, EPD(Entrance pupil diameter) = 10.00 mm, FOV (Field of view) = 100.0°

| | | Radius of | Thickness/ | Refractive | Abbe | Refraction/ |
|---|---|---|---|---|---|---|
| Surface | | curvature | gap | index (nd) | number (vd) | reflection |
| 0 | Stop | Infinity | 14.000 | — | — | — |
| 1 | First lens | −231.119 | 3.384 | 1.544 | 55.9 | Refraction |
| 2 | | −38.654 | 0.300 | — | — | Refraction |
| 3 | First absorptive polarizer | −38.654 | 0.100 | 1.533 | 56.0 | Refraction |
| 4 | Reflective polarizer | −38.654 | 0.100 | 1.533 | 56.0 | Refraction |
| 5 | Second lens | −38.654 | 2.022 | 1.645 | 23.4 | Refraction |
| 6 | First phase retarder | −77.809 | 0.100 | 1.533 | 56.0 | Refraction |
| 7 | Third lens | −77.809 | 7.292 | 1.544 | 55.9 | Refraction |
| 8 | Partial-reflective-partial- | −32.345 | −7.292 | 1.544 | 55.9 | Reflection |
| | transmissive element | | | | | |
| 9 | First phase retarder | −77.809 | −0.100 | 1.533 | 56.0 | Refraction |
| 10 | Second lens | −77.809 | −2.022 | 1.645 | 23.4 | Refraction |
| 11 | Reflective polarizer | −38.654 | −0.100 | 1.533 | 56.0 | Refraction |
| 12 | Reflective polarizer | −38.654 | 0.100 | 1.533 | 56.0 | Reflection |
| 13 | Second lens | −38.654 | 2.022 | 1.645 | 23.4 | Refraction |
| 14 | First phase retarder | −77.809 | 0.100 | 1.533 | 56.0 | Refraction |
| 15 | Third lens | −77.809 | 7.292 | 1.544 | 55.9 | Refraction |
| 16 | Partial-reflective-partial- | −32.345 | 1.500 | — | — | Refraction |
| | transmissive element | | | | | |
| 17 | Second phase retarder | Infinity | 0.100 | 1.533 | 56.0 | Refraction |
| 18 | Second absorptive | Infinity | 0.100 | 1.533 | 56.0 | Refraction |
| | polarizer | | | | | |
| 19 | Image source plane | Infinity | — | — | — | — |

The reference wavelength is 555 nm.

TABLE 18
Embodiment 5
Aspheric Coefficients

| Surface | 1 | 2 | 3, 4, 5, 11, 12, 13 |
|---|---|---|---|
| K: | 8.1872E+01 | −2.0573E+00 | −2.0573E+00 |
| A2: | 0.0000E+00 | 0.0000E+00 | 0.0000E+00 |
| A4: | −2.8954E−05 | 2.8111E−06 | 2.8111E−06 |
| A6: | 5.9795E−08 | −4.6262E−09 | −4.6262E−09 |
| A8: | 1.5083E−10 | 3.6546E−11 | 3.6546E−11 |
| A10: | −3.5218E−13 | −2.2761E−13 | −2.2761E−13 |
| A12: | −2.1943E−15 | 1.0929E−15 | 1.0929E−15 |
| A14: | 3.1388E−18 | −1.8968E−18 | −1.8968E−18 |
| A16: | 0.0000E+00 | 0.0000E+00 | 0.0000E+00 |
| A18: | 0.0000E+00 | 0.0000E+00 | 0.0000E+00 |
| A20: | 0.0000E+00 | 0.0000E+00 | 0.0000E+00 |

| Surface | 6, 10, 14 | 7, 9, 15 | 8, 16 |
|---|---|---|---|
| K: | 0.0000E+00 | 0.0000E+00 | 0.0000E+00 |
| A2: | 0.0000E+00 | 0.0000E+00 | 0.0000E+00 |
| A4: | 0.0000E+00 | 0.0000E+00 | −1.9148E−06 |
| A6: | 0.0000E+00 | 0.0000E+00 | −4.2111E−09 |
| A8: | 0.0000E+00 | 0.0000E+00 | 2.5760E−11 |
| A10: | 0.0000E+00 | 0.0000E+00 | −4.9490E−14 |
| A12: | 0.0000E+00 | 0.0000E+00 | 1.0609E−17 |
| A14: | 0.0000E+00 | 0.0000E+00 | 2.6143E−19 |
| A16: | 0.0000E+00 | 0.0000E+00 | −3.8145E−22 |
| A18: | 0.0000E+00 | 0.0000E+00 | 0.0000E+00 |
| A20: | 0.0000E+00 | 0.0000E+00 | 0.0000E+00 |

TABLE 19
Embodiment 5

| | | | | | | | |
|---|---|---|---|---|---|---|---|
| f1 | [mm] | 84.54 | CA4 | [mm] | 19.11 | TDP5 [mm] | 2.40 |
| f2 | [mm] | −121.71 | TDP1 | [mm] | 1.43 | TDP6 [mm] | 7.71 |
| f3 | [mm] | 96.01 | TDP2 | [mm] | 3.18 | — | — |
| CA1 | [mm] | 15.33 | TDP3 | [mm] | 3.31 | — | — |

TABLE 20
Embodiment 5

| | | | | | |
|---|---|---|---|---|---|
| CA1/TDP1 | 10.76 | f3/f | 5.66 | CT3/CT2 | 3.61 |
| TDP5*TDP6 | 18.49 | f2/f3 | −1.27 | CT3/TDP6 | 0.95 |
| [mm²] | | | | | |
| TDP2*TDP3 | 10.52 | R1/f1 | −2.73 | f1/f2 | −0.69 |
| [mm²] | | | | | |
| f3/R6 | −2.97 | R1/R2 | 5.98 | R6/R5 | 0.42 |
| f1/f | 4.99 | CA4/ | 1.73 | R6/R2 | 0.84 |
| | | (TDP3 + TDP6) | | | |
| f2/CT2 | −60.20 | R1/CT1 | −68.30 | — | — |

### Sixth Embodiment

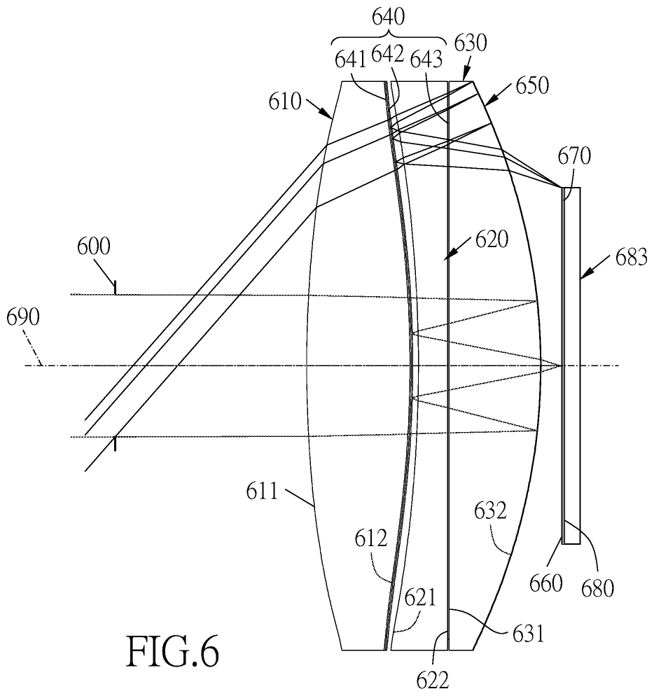

Referring to FIG. 6, an optical lens assembly in accordance with a sixth embodiment of the present invention includes, in order from a visual side to an image source side along an optical axis 690: a stop 600, a first lens 610, a first absorptive polarizer 641, a reflective polarizer 642, a second lens 620, a first phase retarder 643, a third lens 630, a partial-reflective-partial-transmissive element 650, a second phase retarder 660, a second absorptive polarizer 670 and an image source plane 680. The optical lens assembly has a total of three lenses with refractive power, but not is limited thereto. The first absorptive polarizer 641, the reflective polarizer 642 and the first phase retarder 643 form an optical element group 640 located between the first lens 610 and the third lens 630.

The stop 600 may be located in a position where the user's eyes view an image.

The first lens 610 with positive refractive power includes a visual-side surface 611 and an image source-side surface 612, the visual-side surface 611 of the first lens 610 is convex in a paraxial region thereof, the image source-side surface 612 of the first lens 610 is convex in a paraxial region thereof, the visual-side surface 611 and the image source-side surface 612 of the first lens 610 are aspheric, and the first lens 610 is made of plastic.

The second lens 620 with negative refractive power includes a visual-side surface 621 and an image source-side surface 622, the visual-side surface 621 of the second lens 620 is concave in a paraxial region thereof, the image source-side surface 622 of the second lens 620 is flat in a paraxial region thereof, the visual-side surface 621 of the second lens 620 is aspheric, and the second lens 620 is made of plastic.

The third lens 630 with positive refractive power includes a visual-side surface 631 and an image source-side surface 632, the visual-side surface 631 of the third lens 630 is flat in a paraxial region thereof, the image source-side surface 632 of the third lens 630 is convex in a paraxial region thereof, the image source-side surface 632 of the third lens 630 is aspheric, and the third lens 630 is made of plastic.

The first absorptive polarizer 641 is disposed on the image source-side surface 612 of the first lens 610. The reflective polarizer 642 is disposed on an image source-side surface of the first absorptive polarizer 641. The first phase retarder 643 is disposed on the image source-side surface 622 of the second lens 620. The third lens 630 is disposed on an image source-side surface of the first phase retarder 643. The first phase retarder 643 is, for example, but not limited to, a quarter-wave plate.

The configuration of the partial-reflective-partial-transmissive element 650 is the same as that of the partial-reflective-partial-transmissive element 150 of the first embodiment and will not be explained again.

The configuration of the second phase retarder 660 and the second absorptive polarizer 670 is the same as that of the second phase retarder 160 and the second absorptive polarizer 170 of the first embodiment and will not be explained again.

The optical lens assembly works in cooperation with an image source 683 disposed on the image source plane 680. In the present embodiment, the type of the image source 683 is, for example, but not limited to, an OLED display, a LED display, a liquid crystal display, or other displays.

Please refer to Tables 21-24, Table 21 shows the detailed optical data of the elements of the optical lens assembly of the sixth embodiment, Table 22 shows the data of the aspherical surfaces of the lenses of the optical lens assembly of the sixth embodiment, Table 23 shows the remaining parameters of the optical lens assembly of the sixth embodiment and the values thereof, and the values of the parameters in Tables 21 and 23 meet the conditional formulas of Table 24. In the sixth embodiment, the equation of the aspheric surface profiles of the aforementioned lenses is the same as the equation of the aspheric surface profiles of the aforementioned lenses in the first embodiment. The definitions of the surfaces in Table 21 can be referred to the relevant description of Table 1 and will not be explained again.

TABLE 21
Embodiment 6
f = 16.97 mm, EPD(Entrance pupil diameter) = 10.00 mm, FOV (Field of view) = 95.1°

| | | Radius of | Thickness/ | Refractive | Abbe | Refraction/ |
|---|---|---|---|---|---|---|
| Surface | | curvature | gap | Index (nd) | number (vd) | reflection |
| 0 | Stop | Infinity | 14.000 | — | — | — |
| 1 | First lens | 83.382 | 7.542 | 1.544 | 55.9 | Refraction |
| 2 | First absorptive polarizer | −80.795 | 0.100 | 1.533 | 56.0 | Refraction |
| 3 | Reflective polarizer | −80.795 | 0.100 | 1.533 | 56.0 | Refraction |
| 4 | | −80.795 | 0.423 | — | — | Refraction |
| 5 | Second lens | −93.578 | 2.118 | 1.645 | 23.4 | Refraction |
| 6 | First phase retarder | Infinity | 0.100 | 1.533 | 56.0 | Refraction |
| 7 | Third lens | Infinity | 6.713 | 1.544 | 55.9 | Refraction |
| 8 | Partial-reflective-partial- | −41.513 | −6.713 | 1.544 | 55.9 | Reflection |
| | transmissive element | | | | | |
| 9 | First phase retarder | Infinity | −0.100 | 1.533 | 56.0 | Refraction |
| 10 | Second lens | Infinity | −2.118 | 1.645 | 23.4 | Refraction |
| 11 | | −93.578 | −0.423 | — | — | Refraction |
| 12 | Reflective polarizer | −80.795 | −0.100 | 1.533 | 56.0 | Refraction |
| 13 | Reflective polarizer | −80.795 | 0.100 | 1.533 | 56.0 | Reflection |
| 14 | | −80.795 | 0.423 | — | — | Refraction |
| 15 | Second lens | −93.578 | 2.118 | 1.645 | 23.4 | Refraction |
| 16 | First phase retarder | Infinity | 0.100 | 1.533 | 56.0 | Refraction |
| 17 | Third lens | Infinity | 6.713 | 1.544 | 55.9 | Refraction |
| 18 | Partial-reflective-partial- | −41.513 | 1.500 | — | — | Refraction |
| | transmissive element | | | | | |
| 19 | Second phase retarder | Infinity | 0.100 | 1.533 | 56.0 | Refraction |
| 20 | Second absorptive polarizer | Infinity | 0.100 | 1.533 | 56.0 | Refraction |
| 21 | Image source plane | Infinity | — | — | — | — |

The reference wavelength is 555 nm.

TABLE 22
Embodiment 6
Aspheric Coefficients

| Surface | 1 | 2, 3, 4, 12, 13, 14 | 5, 11, 15 |
|---|---|---|---|
| K: | −9.0000E+01 | 3.7495E+00 | −1.5061E+00 |
| A2: | 0.0000E+00 | 0.0000E+00 | 0.0000E+00 |
| A4: | 9.6733E−06 | −7.9206E−07 | 1.5787E−06 |
| A6: | 1.4294E−08 | 2.4728E−08 | 1.1835E−10 |
| A8: | −1.3826E−10 | −4.2775E−11 | −2.3654E−11 |
| A10: | 2.2714E−13 | −1.6001E−14 | −2.5177E−15 |
| A12: | 4.8311E−16 | 3.5910E−16 | 6.6599E−17 |
| A14: | −2.0844E−19 | −3.6482E−19 | 1.0649E−19 |
| A16: | −5.3495E−21 | −4.1686E−22 | 3.6881E−23 |
| A18: | 8.1668E−24 | 0.0000E+00 | 0.0000E+00 |
| A20: | −3.1808E−27 | 0.0000E+00 | 0.0000E+00 |

| Surface | 6, 10, 16 | 7, 9, 17 | 8, 18 |
|---|---|---|---|
| K: | 0.0000E+00 | 0.0000E+00 | 0.0000E+00 |
| A2: | 0.0000E+00 | 0.0000E+00 | 0.0000E+00 |
| A4: | 0.0000E+00 | 0.0000E+00 | 1.8150E−07 |
| A6: | 0.0000E+00 | 0.0000E+00 | 2.3771E−09 |
| A8: | 0.0000E+00 | 0.0000E+00 | −1.7851E−12 |
| A10: | 0.0000E+00 | 0.0000E+00 | 1.0769E−14 |
| A12: | 0.0000E+00 | 0.0000E+00 | −4.0076E−17 |
| A14: | 0.0000E+00 | 0.0000E+00 | −1.4163E−20 |
| A16: | 0.0000E+00 | 0.0000E+00 | 1.5675E−22 |
| A18: | 0.0000E+00 | 0.0000E+00 | 0.0000E+00 |
| A20: | 0.0000E+00 | 0.0000E+00 | 0.0000E+00 |

TABLE 23
Embodiment 6

| | | | | | | | |
|---|---|---|---|---|---|---|---|
| f1 | [mm] | 76.44 | CA4 | [mm] | 19.13 | TDP5 [mm] | 0 |
| f2 | [mm] | −145.27 | TDP1 | [mm] | 1.47 | TDP6 [mm] | 4.95 |
| f3 | [mm] | 76.08 | TDP2 | [mm] | 1.60 | — | — |
| CA1 | [mm] | 15.48 | TDP3 | [mm] | 1.62 | — | — |

TABLE 24
Embodiment 6

| | | | | | |
|---|---|---|---|---|---|
| CA1/TDP1 | 10.52 | f3/f | 4.48 | CT3/CT2 | 3.17 |
| TDP5*TDP6 | 0 | f2/f3 | −1.91 | CT3/TDP6 | 1.36 |
| [mm²] | | | | | |
| TDP2*TDP3 | 2.60 | R1/f1 | 1.09 | f1/f2 | −0.53 |
| [mm²] | | | | | |
| f3/R6 | −1.83 | R1/R2 | −1.03 | R6/R5 | 0 |
| f1/f | 4.50 | CA4/ | 2.91 | R6/R2 | 0.51 |
| | | (TDP3 + TDP6) | | | |
| f2/CT2 | −68.60 | R1/CT1 | 11.06 | — | — |

### Seventh Embodiment

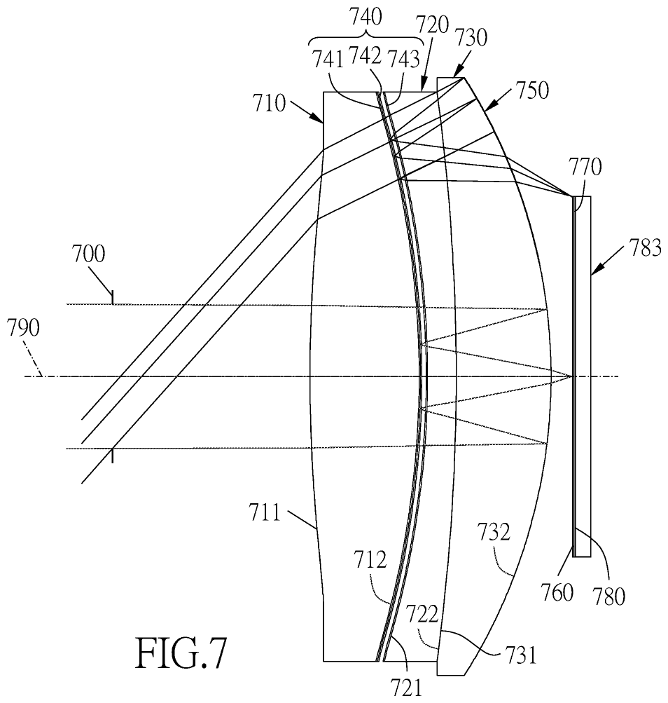

Referring to FIG. 7, an optical lens assembly in accordance with a seventh embodiment of the present invention includes, in order from a visual side to an image source side along an optical axis 790: a stop 700, a first lens 710, a first absorptive polarizer 741, a reflective polarizer 742, a first phase retarder 743, a second lens 720, a third lens 730, a partial-reflective-partial-transmissive element 750, a second phase retarder 760, a second absorptive polarizer 770 and an image source plane 780. The optical lens assembly has a total of three lenses with refractive power, but not is limited thereto. The first absorptive polarizer 741, the reflective polarizer 742 and the first phase retarder 743 form an optical element group 740 located between the first lens 710 and the third lens 730.

The stop 700 may be located in a position where the user's eyes view an image.

The first lens 710 with positive refractive power includes a visual-side surface 711 and an image source-side surface 712, the visual-side surface 711 of the first lens 710 is convex in a paraxial region thereof, the image source-side surface 712 of the first lens 710 is convex in a paraxial region thereof, the visual-side surface 711 and the image source-side surface 712 of the first lens 710 are aspheric, and the first lens 710 is made of plastic.

The second lens 720 with negative refractive power includes a visual-side surface 721 and an image source-side surface 722, the visual-side surface 721 of the second lens 720 is concave in a paraxial region thereof, the image source-side surface 722 of the second lens 720 is convex in a paraxial region thereof, the visual-side surface 721 and the image source-side surface 722 of the second lens 720 are aspheric, and the second lens 720 is made of plastic.

The third lens 730 with positive refractive power includes a visual-side surface 731 and an image source-side surface 732, the visual-side surface 731 of the third lens 730 is concave in a paraxial region thereof, the image source-side surface 732 of the third lens 730 is convex in a paraxial region thereof, the visual-side surface 731 and the image source-side surface 732 of the third lens 730 are aspheric, and the third lens 730 is made of plastic. The second lens 720 and the third lens 730 together form a cemented doublet lens.

The configuration of the first absorptive polarizer 741, the reflective polarizer 742 and the first phase retarder 743 is the same as that of the first absorptive polarizer 141, the reflective polarizer 142 and the first phase retarder 143 of the first embodiment and will not be explained again.

The configuration of the partial-reflective-partial-transmissive element 750 is the same as that of the partial-reflective-partial-transmissive element 150 of the first embodiment and will not be explained again.

The configuration of the second phase retarder 760 and the second absorptive polarizer 770 is the same as that of the second phase retarder 160 and the second absorptive polarizer 170 of the first embodiment and will not be explained again.

The optical lens assembly works in cooperation with an image source 783 disposed on the image source plane 780. In the present embodiment, the type of the image source 783 is, for example, but not limited to, an OLED display, a LED display, a liquid crystal display, or other displays.

Please refer to Tables 25-28, Table 25 shows the detailed optical data of the elements of the optical lens assembly of the seventh embodiment, Table 26 shows the data of the aspherical surfaces of the lenses of the optical lens assembly of the seventh embodiment, Table 27 shows the remaining parameters of the optical lens assembly of the seventh embodiment and the values thereof, and the values of the parameters in Tables 25 and 27 meet the conditional formulas of Table 28. In the seventh embodiment, the equation of the aspheric surface profiles of the aforementioned lenses is the same as the equation of the aspheric surface profiles of the aforementioned lenses in the first embodiment. The definitions of the surfaces in Table 25 can be referred to the relevant description of Table 1 and will not be explained again.

TABLE 25
Embodiment 7
f = 16.77 mm, EPD(Entrance pupil diameter) = 10.00 mm, FOV (Field of view) = 95.0°

| | | Radius of | Thickness/ | Refractive | Abbe | Refraction/ |
|---|---|---|---|---|---|---|
| Surface | | curvature | gap | index (nd) | number (vd) | reflection |
| 0 | Stop | Infinity | 14.000 | — | — | — |
| 1 | First lens | 106.944 | 7.738 | 1.544 | 55.9 | Refraction |
| 2 | First absorptive polarizer | −61.435 | 0.100 | 1.533 | 56.0 | Refraction |
| 3 | Reflective polarizer | −61.435 | 0.100 | 1.533 | 56.0 | Refraction |
| 4 | | −61.435 | 0.300 | — | — | Refraction |
| 5 | First phase retarder | −61.435 | 0.100 | 1.533 | 56.0 | Refraction |
| 6 | Second lens | −61.435 | 2.027 | 1.645 | 23.4 | Refraction |
| 7 | Third lens | −143.734 | 6.726 | 1.544 | 55.9 | Refraction |
| 8 | Partial-reflective-partial- | −37.688 | −6.726 | 1.544 | 55.9 | Reflection |
| | transmissive element | | | | | |
| 9 | Second lens | −143.734 | −2.027 | 1.645 | 23.4 | Refraction |
| 10 | First phase retarder | −61.435 | −0.100 | 1.533 | 56.0 | Refraction |
| 11 | | −61.435 | −0.300 | — | — | Refraction |
| 12 | Reflective polarizer | −61.435 | −0.100 | 1.533 | 56.0 | Refraction |
| 13 | Reflective polarizer | −61.435 | 0.100 | 1.533 | 56.0 | Reflection |
| 14 | | −61.435 | 0.300 | — | — | Refraction |
| 15 | First phase retarder | −61.435 | 0.100 | 1.533 | 56.0 | Refraction |
| 16 | Second lens | −61.435 | 2.027 | 1.645 | 23.4 | Refraction |
| 17 | Third lens | −143.734 | 6.726 | 1.544 | 55.9 | Refraction |
| 18 | Partial-reflective-partial- | −37.688 | 1.500 | — | — | Refraction |
| | transmissive element | | | | | |
| 19 | Second phase retarder | Infinity | 0.100 | 1.533 | 56.0 | Refraction |
| 20 | Second absorptive polarizer | Infinity | 0.100 | 1.533 | 56.0 | Refraction |
| 21 | Image source plane | Infinity | — | — | — | — |

The reference wavelength is 555 nm.

TABLE 26
Embodiment 7
Aspheric Coefficients

| Surface | 1 | 2, 3, 4, 12, 13, 14 | 6, 10, 16 | 7, 9, 17 | 8, 18 |
|---|---|---|---|---|---|
| K: | −9.0000E+01 | −2.1538E+00 | −2.1538E+00 | 0.0000E+00 | 0.0000E+00 |
| A2: | 0.0000E+00 | 0.0000E+00 | 0.0000E+00 | 0.0000E+00 | 0.0000E+00 |
| A4: | 4.5955E−06 | 1.2516E−06 | 1.2516E−06 | 0.0000E+00 | 3.3909E−07 |
| A6: | 1.6384E−08 | 8.1693E−12 | 8.1693E−12 | 0.0000E+00 | 1.0182E−09 |
| A8: | −1.5559E−10 | −2.6664E−11 | −2.6664E−11 | 0.0000E+00 | −1.7419E−12 |
| A10: | 1.1012E−13 | 2.1477E−15 | 2.1477E−15 | 0.0000E+00 | 1.1701E−14 |
| A12: | 3.1420E−16 | 8.8849E−17 | 8.8849E−17 | 0.0000E+00 | −3.8042E−17 |
| A14: | 1.2589E−19 | 9.0465E−20 | 9.0465E−20 | 0.0000E+00 | −2.4593E−20 |
| A16: | −2.6016E−21 | 0.0000E+00 | 0.0000E+00 | 0.0000E+00 | 1.0018E−22 |
| A18: | 1.3418E−23 | 0.0000E+00 | 0.0000E+00 | 0.0000E+00 | 0.0000E+00 |
| A20: | −3.1980E−26 | 0.0000E+00 | 0.0000E+00 | 0.0000E+00 | 0.0000E+00 |

TABLE 27
Embodiment 7

| | | | | | | | |
|---|---|---|---|---|---|---|---|
| f1 | [mm] | 72.69 | CA4 | [mm] | 19.76 | TDP5 [mm] | 1.37 |
| f2 | [mm] | −168.19 | TDP1 | [mm] | 0.97 | TDP6 [mm] | 6.16 |
| f3 | [mm] | 91.56 | TDP2 | [mm] | 2.55 | — | — |
| CA1 | [mm] | 15.74 | TDP3 | [mm] | 2.64 | — | — |

TABLE 28
Embodiment 7

| | | | | | |
|---|---|---|---|---|---|
| CA1/TDP1 | 16.31 | f3/f | 5.46 | CT3/CT2 | 3.32 |
| TDP5*TDP6 | 8.41 | f2/f3 | −1.84 | CT3/TDP6 | 1.09 |
| [mm²] | | | | | |
| TDP2*TDP3 | 6.73 | R1/f1 | 1.47 | f1/f2 | −0.43 |
| [mm²] | | | | | |
| f3/R6 | −2.43 | R1/R2 | −1.74 | R6/R5 | 0.26 |
| f1/f | 4.33 | CA4/ | 2.25 | R6/R2 | 0.61 |
| | | (TDP3 + TDP6) | | | |
| f2/CT2 | −82.97 | R1/CT1 | 13.82 | — | — |

### Eighth Embodiment

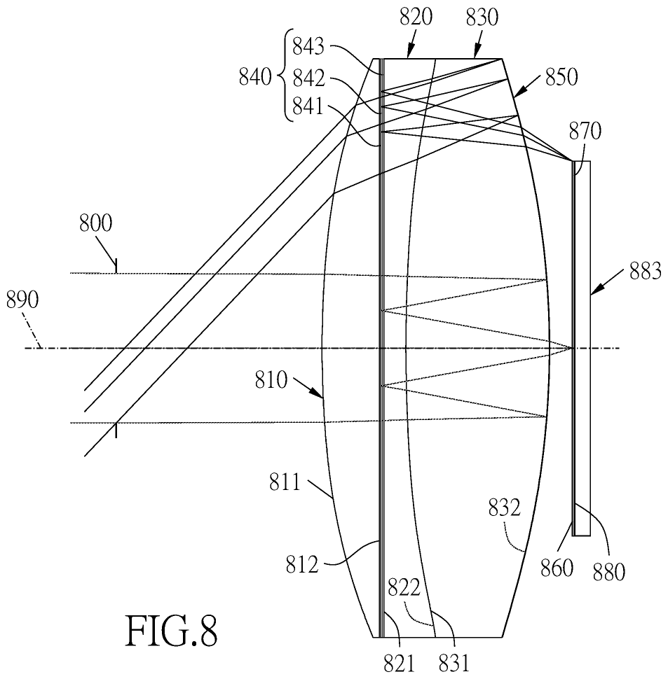

Referring to FIG. 8, an optical lens assembly in accordance with an eighth embodiment of the present invention includes, in order from a visual side to an image source side along an optical axis 890: a stop 800, a first lens 810, a first absorptive polarizer 841, a reflective polarizer 842, a first phase retarder 843, a second lens 820, a third lens 830, a partial-reflective-partial-transmissive element 850, a second phase retarder 860, a second absorptive polarizer 870 and an image source plane 880. The optical lens assembly has a total of three lenses with refractive power, but not is limited thereto. The first absorptive polarizer 841, the reflective polarizer 842 and the first phase retarder 843 form an optical element group 840 located between the first lens 810 and the third lens 830.

The stop 800 may be located in a position where the user's eyes view an image.

The first lens 810 with positive refractive power includes a visual-side surface 811 and an image source-side surface 812, the visual-side surface 811 of the first lens 810 is convex in a paraxial region thereof, the image source-side surface 812 of the first lens 810 is flat in a paraxial region thereof, the image source-side surface 812 of the first lens 810 is aspheric, and the first lens 810 is made of plastic.

The second lens 820 with negative refractive power includes a visual-side surface 821 and an image source-side surface 822, the visual-side surface 821 of the second lens 820 is flat in a paraxial region thereof, the image source-side surface 822 of the second lens 820 is concave in a paraxial region thereof, the image source-side surface 822 of the second lens 820 is aspheric, and the second lens 820 is made of plastic.

The third lens 830 with positive refractive power includes a visual-side surface 831 and an image source-side surface 832, the visual-side surface 831 of the third lens 830 is convex in a paraxial region thereof, the image source-side surface 832 of the third lens 830 is convex in a paraxial region thereof, the visual-side surface 831 and the image source-side surface 832 of the third lens 830 are aspheric, and the third lens 830 is made of plastic. The second lens 820 and the third lens 830 together form a cemented doublet lens.

The optical element group 840 includes, in order from the visual side to the image source side along the optical axis 890: the first absorptive polarizer 841, the reflective polarizer 842 and the first phase retarder 843. The first absorptive polarizer 841 is disposed on the image source-side surface 812 of the first lens 810. The reflective polarizer 842 is disposed on an image source-side surface of the first absorptive polarizer 841. The first phase retarder 843 is disposed on an image source-side surface of the reflective polarizer 842. The second lens 820 is disposed on an image source-side surface of the first phase retarder 843. The first phase retarder 843 is, for example, but not limited to, a quarter-wave plate.

The configuration of the partial-reflective-partial-transmissive element 850 is the same as that of the partial-reflective-partial-transmissive element 150 of the first embodiment and will not be explained again.

The configuration of the second phase retarder 860 and the second absorptive polarizer 870 is the same as that of the second phase retarder 160 and the second absorptive polarizer 170 of the first embodiment and will not be explained again.

The optical lens assembly works in cooperation with an image source 883 disposed on the image source plane 880. In the present embodiment, the type of the image source 883 is, for example, but not limited to, an OLED display, a LED display, a liquid crystal display, or other displays.

Please refer to Tables 29-32, Table 29 shows the detailed optical data of the elements of the optical lens assembly of the eighth embodiment, Table 30 shows the data of the aspherical surfaces of the lenses of the optical lens assembly of the eighth embodiment, Table 31 shows the remaining parameters of the optical lens assembly of the eighth embodiment and the values thereof, and the values of the parameters in Tables 29 and 31 meet the conditional formulas of Table 32. In the eighth embodiment, the equation of the aspheric surface profiles of the aforementioned lenses is the same as the equation of the aspheric surface profiles of the aforementioned lenses in the first embodiment. The definitions of the surfaces in Table 29 can be referred to the relevant description of Table 1 and will not be explained again.

TABLE 29
Embodiment 8
f = 17.56 mm, EPD(Entrance pupil diameter) = 10.00 mm, FOV (Field of view) = 92.0°

| | | Radius of | Thickness/ | Refractive | Abbe | Refraction/ |
|---|---|---|---|---|---|---|
| Surface | | curvature | gap | index (nd) | number (vd) | reflection |
| 0 | Stop | Infinity | 14.000 | — | — | — |
| 1 | First lens | 72.696 | 3.894 | 1.544 | 55.9 | Refraction |
| 2 | First absorptive polarizer | Infinity | 0.100 | 1.533 | 56.0 | Refraction |
| 3 | Reflective polarizer | Infinity | 0.100 | 1.533 | 56.0 | Refraction |
| 4 | First phase retarder | Infinity | 0.100 | 1.533 | 56.0 | Refraction |
| 5 | Second lens | Infinity | 1.500 | 1.645 | 23.4 | Refraction |
| 6 | Third lens | 100.000 | 9.764 | 1.544 | 55.9 | Refraction |
| 7 | Partial-reflective-partial- | −57.057 | −9.764 | 1.544 | 55.9 | Reflection |
| | transmissive element | | | | | |
| 8 | Second lens | 100.000 | −1.500 | 1.645 | 23.4 | Refraction |
| 9 | First phase retarder | Infinity | −0.100 | 1.533 | 56.0 | Refraction |
| 10 | Reflective polarizer | Infinity | −0.100 | 1.533 | 56.0 | Refraction |
| 11 | Reflective polarizer | Infinity | 0.100 | 1.533 | 56.0 | Reflection |
| 12 | First phase retarder | Infinity | 0.100 | 1.533 | 56.0 | Refraction |
| 13 | Second lens | Infinity | 1.500 | 1.645 | 23.4 | Refraction |
| 14 | Third lens | 100.000 | 9.764 | 1.544 | 55.9 | Refraction |
| 15 | Partial-reflective-partial- | −57.057 | 1.500 | — | — | Refraction |
| | transmissive element | | | | | |
| 16 | Second phase retarder | Infinity | 0.100 | 1.533 | 56.0 | Refraction |
| 17 | Second absorptive polarizer | Infinity | 0.100 | 1.533 | 56.0 | Refraction |
| 18 | Image source plane | Infinity | — | — | — | — |

The reference wavelength is 555 nm.

TABLE 30
Embodiment 8
Aspheric Coefficients

| Surface | 1 | 2 | 5, 9 | 6, 8, 14 | 7, 15 |
|---|---|---|---|---|---|
| K: | −9.0000E+01 | 0.0000E+00 | 0.0000E+00 | 0.0000E+00 | 0.0000E+00 |
| A2: | 0.0000E+00 | 0.0000E+00 | 0.0000E+00 | 0.0000E+00 | 0.0000E+00 |
| A4: | 2.3324E−05 | 0.0000E+00 | 0.0000E+00 | −1.6489E−05 | 2.8925E−06 |
| A6: | −3.0425E−09 | 0.0000E+00 | 0.0000E+00 | 1.7892E−07 | −2.5927E−08 |
| A8: | −1.5296E−10 | 0.0000E+00 | 0.0000E+00 | −4.9975E−10 | 7.1415E−11 |
| A10: | 2.3066E−13 | 0.0000E+00 | 0.0000E+00 | −4.6148E−13 | 4.1700E−14 |
| A12: | 4.8803E−16 | 0.0000E+00 | 0.0000E+00 | 4.2838E−15 | −2.0875E−16 |
| A14: | −1.6700E−19 | 0.0000E+00 | 0.0000E+00 | −5.3697E−18 | −2.8512E−19 |
| A16: | −5.1540E−21 | 0.0000E+00 | 0.0000E+00 | 0.0000E+00 | 7.0875E−22 |
| A18: | 8.6254E−24 | 0.0000E+00 | 0.0000E+00 | 0.0000E+00 | 0.0000E+00 |
| A20: | −3.1626E−27 | 0.0000E+00 | 0.0000E+00 | 0.0000E+00 | 0.0000E+00 |

TABLE 31
Embodiment 8

| | | | | | | | |
|---|---|---|---|---|---|---|---|
| f1 | [mm] | 133.22 | CA4 | [mm] | 18.14 | TDP5 [mm] | 1.80 |
| f2 | [mm] | −155.24 | TDP1 | [mm] | 2.34 | TDP6 [mm] | 3.26 |
| f3 | [mm] | 68.07 | TDP2 | [mm] | 0 | — | — |
| CA1 | [mm] | 16.41 | TDP3 | [mm] | 0 | — | — |

TABLE 32
Embodiment 8

| | | | | | |
|---|---|---|---|---|---|
| CA1/TDP1 | 7.00 | f3/f | 3.88 | CT3/CT2 | 6.51 |
| TDP5*TDP6 | 5.87 | f2/f3 | −2.28 | CT3/TDP6 | 3.00 |
| [mm²] | | | | | |
| TDP2*TDP3 | 0 | R1/f1 | 0.55 | f1/f2 | −0.86 |
| [mm²] | | | | | |
| f3/R6 | −1.19 | R1/R2 | 0 | R6/R5 | −0.57 |
| f1/f | 7.59 | CA4/ | 5.57 | R6/R2 | 0 |
| | | (TDP3 + TDP6) | | | |
| f2/CT2 | −103.50 | R1/CT1 | 18.67 | — | — |

For the optical lens assembly in the present invention, the lenses can be made of plastic or glass. If the lens is made of plastic, it is conducive to reducing the manufacturing cost. If the lens is made of glass, it is conducive to enhancing the degree of freedom in the arrangement of refractive power of the optical lens assembly.

For the optical lens assembly in the present invention, the aspheric surface can have any profile shape other than the profile shape of a spherical surface, so more variables can be used in the design of aspheric surfaces (than spherical surfaces), which is conducive to reducing the aberration and the number of lenses, as well as the total length of the optical lens assembly.

For the optical lens assembly in the present invention, if the surface shape of a respective lens surface of a respective lens with refractive power is convex and the location of the convex portion of the respective lens surface of the respective lens is not defined, the convex portion is typically located in a paraxial region of the respective lens surface of the respective lens. If the surface shape of a respective lens surface of a respective lens is concave and the location of the concave portion of the respective lens surface of the respective lens is not defined, the concave portion is typically located in a paraxial region of the respective lens surface of the respective lens.

For the optical lens assembly in the present invention, the maximum effective radius of the lens surface is usually a radius of the effective optical region of the lens surface (i.e., a region which is not subjected to any surface treatment or extinction processing or is not provided with any shade).

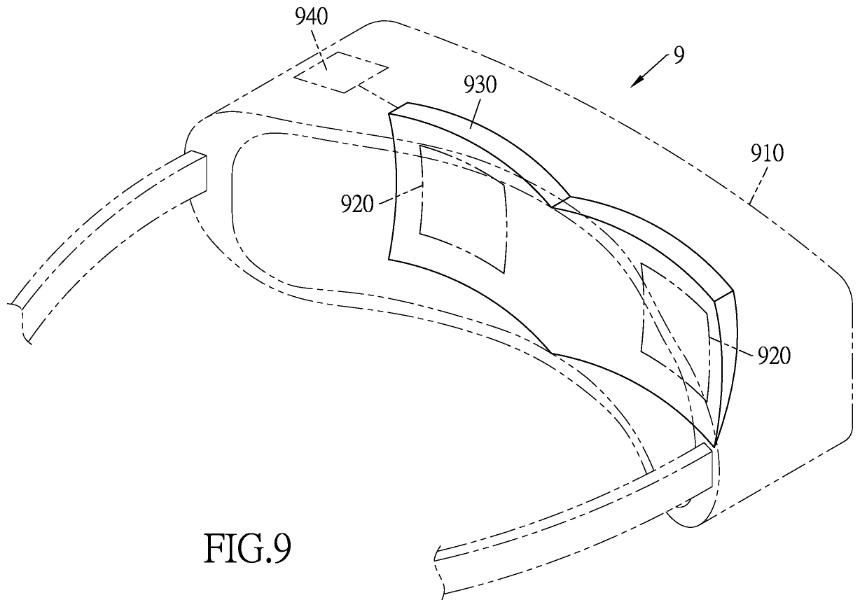

The optical lens assembly of the present invention can be used in head-mounted electronic devices as required. FIG. 9 shows a head-mounted electronic device in accordance with an embodiment of the present invention. The head-mounted electronic device 9 is a head-mounted display device using, but not limited to, virtual reality (VR) technology, augmented reality (AR) technology and mixed reality (MR) technology, and includes a housing 910, an optical module 920, an image source 930 and a controller 940.

The optical module 920 corresponds to the left and right eyes of the user. The optical module 920 includes an optical lens assembly described in any one of the first to eighth embodiments.

The image source 930 can be an image source described in any one of the first to eighth embodiments. The image source 930 corresponds to the left and right eyes of the user, and the type of the image source 930 may be an OLED display, a LED display, a liquid crystal display, or other display, but is not limited thereto.

The controller 940 is electrically connected to the image source 930, so as to control the image source 930 to display an image, whereby the head-mounted electronic device 9 can project the image to the eyes of the user.

What is claimed is:

1. An optical lens assembly, comprising:
a first lens with positive refractive power;
an optical element group comprising, in order from a visual side to an image source side: an absorptive polarizer, a reflective polarizer and a phase retarder;
a second lens with refractive power;
a third lens with refractive power, and an image source-side surface of the third lens being convex in a paraxial region thereof; and
a partial-reflective-partial-transmissive element;
wherein the first lens, the second lens, the third lens and the partial-reflective-partial-transmissive element are sequentially arranged from the visual side to the image source side, the optical element group is disposed between the first lens and the third lens, the phase retarder is disposed between the reflective polarizer and the third lens, a maximum effective radius of a visual-side surface of the first lens is CA1, an absolute value of a displacement in parallel to an optical axis from an intersection between the visual-side surface of the first lens and the optical axis to the maximum effective radius position on the visual-side surface of the first lens is TDP1, and the following condition is satisfied: 5.60<CA1/TDP1<256.36.

2. The optical lens assembly as claimed in claim 1, wherein an absolute value of a displacement in parallel to the optical axis from an intersection between a visual-side surface of the third lens and the optical axis to the maximum effective radius position on the visual-side surface of the third lens is TDP5, an absolute value of a displacement in parallel to the optical axis from an intersection between the image source-side surface of the third lens and the optical axis to the maximum effective radius position on the image source-side surface of the third lens is TDP6, and the following condition is satisfied: 0 mm²<TDP5*TDP6<26.95 mm².

3. The optical lens assembly as claimed in claim 1, wherein an absolute value of a displacement in parallel to the optical axis from an intersection between an image source-side surface of the first lens and the optical axis to the maximum effective radius position on the image source-side surface of the first lens is TDP2, an absolute value of a displacement in parallel to the optical axis from an intersection between a visual-side surface of the second lens and the optical axis to the maximum effective radius position on the visual-side surface of the second lens is TDP3, and at the following condition is satisfied: 0 mm²<TDP2*TDP3<16.82 mm².

4. The optical lens assembly as claimed in claim 1, wherein a focal length of the third lens is f3, a radius of curvature of the image source-side surface of the third lens is R6, and the following condition is satisfied: −3.56<f3/R6<5.12.

5. The optical lens assembly as claimed in claim 1, wherein a focal length of the first lens is f1, a focal length of the optical lens assembly is f, and the following condition is satisfied: 3.46<f1/f<12.15.

6. The optical lens assembly as claimed in claim 1, wherein a focal length of the second lens is f2, a thickness of the second lens along the optical axis is CT2, and the following condition is satisfied: −124.19<f2/CT2<9.78.

7. The optical lens assembly as claimed in claim 1, wherein a focal length of the third lens is f3, a focal length of the optical lens assembly is f, and the following condition is satisfied: −14.64<f3/f<6.80.

8. The optical lens assembly as claimed in claim 1, wherein a focal length of the second lens is f2, a focal length of the third lens is f3, and the following condition is satisfied:−3.25<f2/f3<−0.25.

9. The optical lens assembly as claimed in claim 1, wherein a radius of curvature of the visual-side surface of the first lens is R1, a focal length of the first lens is f1, and the following condition is satisfied: −4.04<R1/f1<1.95.

10. The optical lens assembly as claimed in claim 1, wherein a radius of curvature of the visual-side surface of the first lens is R1, a radius of curvature of an image source-side surface of the first lens is R2, and the following condition is satisfied: −2.38<R1/R2<8.55.

11. The optical lens assembly as claimed in claim 1, wherein a maximum effective radius of an image source-side surface of the second lens is CA4, an absolute value of a displacement in parallel to the optical axis from an intersection between a visual-side surface of the second lens and the optical axis to the maximum effective radius position on the visual-side surface of the second lens is TDP3, an absolute value of a displacement in parallel to the optical axis from an intersection between the image source-side surface of the third lens and the optical axis to the maximum effective radius position on the image source-side surface of the third lens is TDP6, and the following condition is satisfied: 1.39<CA4/(TDP3+TDP6)<6.68.

12. The optical lens assembly as claimed in claim 1, wherein a radius of curvature of the visual-side surface of the first lens is R1, a thickness of the first lens along the optical axis is CT1, and the following condition is satisfied: −81.96<R1/CT1<150.14.

13. The optical lens assembly as claimed in claim 1, wherein a thickness of the second lens along the optical axis is CT2, a thickness of the third lens along the optical axis is CT3, and the following condition is satisfied: 0.23<CT3/CT2<7.81.

14. The optical lens assembly as claimed in claim 1, wherein a thickness of the third lens along the optical axis is CT3, an absolute value of a displacement in parallel to the optical axis from an intersection between the image source-side surface of the third lens and the optical axis to the maximum effective radius position on the image source-side surface of the third lens is TDP6, and the following condition is satisfied: 0.45<CT3/TDP6<3.60.

15. A head-mounted electronic device, comprising:
a housing;
an optical lens assembly disposed in the housing;
an image source disposed on an image source plane of the optical lens assembly in the housing; and
a controller disposed in the housing and electrically connected to the image source;
wherein the optical lens assembly comprising:
a first lens with positive refractive power;
an optical element group comprising, in order from a visual side to an image source side: an absorptive polarizer, a reflective polarizer and a phase retarder;
a second lens with refractive power;
a third lens with refractive power, and an image source-side surface of the third lens being convex in a paraxial region thereof; and
a partial-reflective-partial-transmissive element;
wherein the first lens, the second lens, the third lens and the partial-reflective-partial-transmissive element are sequentially arranged from the visual side to the image source side, the optical element group is disposed between the first lens and the third lens, the phase retarder is disposed between the reflective polarizer and the third lens, a maximum effective radius of a visual-side surface of the first lens is CA1, an absolute value of a displacement in parallel to an optical axis from an intersection between the visual-side surface of the first lens and the optical axis to the maximum effective radius position on the visual-side surface of the first lens is TDP1, and the following condition is satisfied: 5.60<CA1/TDP1<256.36.

16. The head-mounted electronic device as claimed in claim 15, wherein an absolute value of a displacement in parallel to the optical axis from an intersection between a visual-side surface of the third lens and the optical axis to the maximum effective radius position on the visual-side surface of the third lens is TDP5, an absolute value of a displacement in parallel to the optical axis from an intersection between the image source-side surface of the third lens and the optical axis to the maximum effective radius position on the image source-side surface of the third lens is TDP6, and the following condition is satisfied: 0 mm²<TDP5*TDP6<26.95 mm².

17. The head-mounted electronic device as claimed in claim 15, wherein a focal length of the second lens is f2, a thickness of the second lens along the optical axis is CT2, and the following condition is satisfied: −124.19<f2/CT2<9.78.

18. The head-mounted electronic device as claimed in claim 15, wherein a radius of curvature of the visual-side surface of the first lens is R1, a radius of curvature of an image source-side surface of the first lens is R2, and the following condition is satisfied: −2.38<R1/R2<8.55.

19. The head-mounted electronic device as claimed in claim 15, wherein a maximum effective radius of an image source-side surface of the second lens is CA4, an absolute value of a displacement in parallel to the optical axis from an intersection between a visual-side surface of the second lens and the optical axis to the maximum effective radius position on the visual-side surface of the second lens is TDP3, an absolute value of a displacement in parallel to the optical axis from an intersection between the image source-side surface of the third lens and the optical axis to the maximum effective radius position on the image source-side surface of the third lens is TDP6, and the following condition is satisfied: 1.39<CA4/(TDP3+TDP6)<6.68.

20. The head-mounted electronic device as claimed in claim 15, wherein a thickness of the second lens along the optical axis is CT2, a thickness of the third lens along the optical axis is CT3, and the following condition is satisfied: 0.23<CT3/CT2<7.81.
